(19) United States
(12) Patent Application Publication
(10) Pub. No.: US 2012/0044256 A1
(43) Pub. Date: Feb. 23, 2012

(54) RELATIONSHIP INFORMATION DISPLAY DEVICE, RELATIONSHIP INFORMATION DISPLAY METHOD AND RELATIONSHIP INFORMATION DISPLAY PROGRAM

(76) Inventors: Akiko Ide, Tokyo (JP); Ryosuke Okubo, Tokyo (JP)

(21) Appl. No.: 13/262,957

(22) PCT Filed: Apr. 14, 2010
(86) PCT No.: PCT/JP2010/056955

§ 371 Date: Oct. 5, 2011

(30) Foreign Application Priority Data
Apr. 16, 2009 (JP) 2009-099673

(51) Int. Cl. G09G 5/00

(52) U.S. Cl. 345/619

(57) ABSTRACT

A relationship information display device comprises a display information generation section, a display control unit, and a display area moving section, and displays the identification mark of no-attention information in which the distance calculated from the relationship strength with attention information is included in a predetermined range that can be changed by the operation of a user. The relationship information display device displays the identification mark of the no-attention information at the position at which the distance from a position serving as a reference is the distance calculated on the basis of the relationship strength between the attention information and the no-attention information in a state in which the position serving as the reference associated with the attention information is fixed even if a display range is changed. The relationship information display device docs not display the identification mark of the no-attention information if the distance associated with the no-attention information is not included in the predetermined range.

### TECHNICAL FIELD

The present invention relates to a relationship information display device, a relationship information display method and a relationship information display program which displays relationship information representing relationship between specific information which is paid attention and other information. The present invention can be used suitably for a device having a visual display device and an operation key such as, for example, a television, a mobile phone and a computer.

### BACKGROUND ART

When a user performs various investigations or analyses, there are often cases when grasping relation between pieces of information which composes a target of analysis becomes necessary. At such a time, there is a case when the user may not need to grasp uniformly the mutual relationship of each two of the information pieces which are the target of analysis, but to grasp the relationship between the specific information (hereinafter, referred to as attention information) which should be paid attention and information other than that by a computer.

As such an example, there is human relationship around a certain specific person.

As another example, there is a degree of similarity of other user's tastes against a certain user's taste. For example, suppose that we want to select contents, such as movies and music, to be presented to a certain user from among contents other user, who has a taste of contents close to that of the certain user, bought in the past. In this case, it is necessary to grasp closeness of the tastes of the other user to the tastes of the user who is a target of the presentation of contents.

Further, as another example, there is strength of user's interest in contents, such as movies and music. In this case, the user is attention information and each of contents is information other than that. In order to present the contents to the user in which the user has an interest, it is necessary to grasp the strength of the user's interest in each of the contents.

Generally, to express visually relationship information which is a result which analyzed relationship between attention information and information other than that is important in order to help understanding of the contents.

As a first related technology of the present invention which expresses visually relationship between attention information and information other than that, there is a relation display device described in patent document 1. The relation display device of patent document 1 generates a figure which arranges attention information at a center of a polar coordinate system and arranges information other than that at a predetermined position around it. Further, the relation display device illustrates by the figure relationship strength which is strength of relationship between two different pieces of information. This first related technology represents the strength of relationship between the attention information and the no-attention information which is information other than the attention information by radius vector length of the position of the no-attention information which is distance between the two. The first related technology displays the no-attention information close to an origin which corresponds to the position of the attention information by making such that the larger the relationship strength between the no-attention information and the attention information is, the smaller the radius vector length of the position where the no-attention information is displayed becomes. Also, the strength of relationship between the no-attention information is represented by a central angle which is formed by two points at which this no-attention information is arranged and the center of the polar coordinate system at which the attention information is arranged. On the other hand, the relation display device of patent document I does not display no-attention information which has no relationship with the attention information.

FIG. 25 shows an example of display of relationship information by this first related technology. Here, suppose the attention information is information D01. The information D01 is arranged at the origin which is the center of the polar coordinate system. Relationship strength of no-attention information D02-D07 to the information D01 is expressed by radius vector length of four levels. Relationship strength among the no-attention information D02-D07 is expressed by a size of the central angle which the origin and the position of each of the no-attention information form. In an example of FIG. 25, the larger the relationship strength between two of the no-attention information is, the smaller the central angle becomes. Also, the smaller the relationship strength between two of the no-attention information is, the larger the central angle becomes. FIG. 26 illustrates the relationship strength among the information D01-D07 in the example of display of FIG. 25. This relationship strength explanatory drawing displays each of the information D01-D07 in a matrix form. Here, the relationship strength among each of the information D01-D07 is expressed by a set of a column item and a row item corresponding to each. For example, the relationship strength of the attention information D01 and the no-attention information D02 is numerical value “4”. Also, the relationship strength of the no-attention information D02 and the no-attention information D04 is numerical value “0”. Although numerical values representing the relationship strength among each of the information D01-D07 are expressed by integers in FIG. 26, they may not be limited to integers necessarily. Numerical values representing the relationship strength may be real numbers.

In FIG. 26, although the relationship strength among each of the information D01-D07 is represented by numerical values, these relationships cannot be grasped intuitively only from this figure. Accordingly, in the first related technology, these relationships are expressed by the figure as shown in FIG. 25. The relationship display device of the first related technology arranges the attention information D01 at the origin of the polar coordinate system, and arranges the no-attention information D02-D07 so that the stronger the relationship strength with the attention information D01 is, the shorter the radius vector which is the distance from the origin becomes. For example, the relationship strength between the attention information D01 and the no-attention information D02 represented by numerical value “4” is larger than the relationship strength between the attention information D01 and the no-attention information D03 represented by numerical value “3”. Accordingly, in FIG. 25, a radius vector r0102 is shorter than a radius vector r0103. Also, the relationship strength between the attention information D01 and the no-attention information D07 represented by numerical value “1” is smaller than the relationship strength between the attention information D01 and the no-attention information D03 represented by numerical value “3”. Accordingly, in FIG. 25, a radius vector r0107 illustrating the relationship strength of the attention information D01 and the no-attention information D07 is longer than the radius vector r0102 or the radius vector r0103. On the other hand, because the relationship strength of the attention information D01 and no-attention information D08 shown in FIG. 26 is numerical value “0”, the no-attention information D08 is not displayed in FIG. 25.

Also, referring to FIG. 26, the relationship strength between the no-attention information D02 and D03 is numerical value “4”. On the other hand, the relationship strength between the no-attention information D04 and D07 is numerical value “0” and is smaller than the relationship strength between the no-attention information D02 and D03. Accordingly, in FIG. 25, a central angle θ0203 illustrating the relationship strength between the no-attention information D02 and D03 is smaller than a central angle θ0407 illustrating the relationship strength between the no-attention information D04 and D07.

### Preceding Technical Literature

[Patent Document]

[Patent document 1] Japanese Patent Application Laid-Open No. 2007-249641 (paragraphs 0020-0023, FIG. 2 and FIG. 3)

### BRIEF SUMMARY OF THE INVENTION

### Problems to be Solved by the Invention

As mentioned above, by using the first related technology, the relationship strength between the attention information and the no-attention information and the relationship strength between the no-attention information can be illustrated as a figure. However, in case the first related technology is applied to an information processing device whose resolution is relatively low and whose area of a display screen is limited, there is a problem that to display arrangement of the whole information on one display screen becomes difficult. For example, in case a small information processing device, such as a mobile phone, makes display as shown in FIG. 25, it is not possible to distinguish clearly display positions of three of the no-attention information D02, D03 and D06 arranged close to each other. Display positions of two of the no-attention information D04 and D05 also have a similar problem as a result of their coming too close in terms of positions.

Such a problem of display can be solved by: not displaying the whole of the arrangement relationship of each of the information D01, D02 . . . on a screen at one time, but by extracting and expanding a partial area from this and displaying it on one display screen, together by moving the area extracted part by part. However, among the information processing devices including a display screen, in devices, such as a mobile phone or a television device, input devices have a relatively simple structure different from a pointing device such as a mouse. For example, there are many cases where a mobile phone or a television device uses a cross key as an input device which directs movement direction.

In case a cross key is used, although designation of angular orientation of multiples of 90 degrees is easy, it is difficult to move a display area to an oblique direction as the direction other than these. Accordingly, when moving the display area using the cross key, movement operation in the direction other than the angular orientation of multiples of 90 degrees is difficult to understand, is difficult to remember and is apt to cause an error in operation. There is also a similar problem for other simplified type of input devices concerning movement of the display area or change in a display range. Although a case where the polar coordinate is used for display has been described, even in case other coordinate systems are used, there is a similar problem concerning movement of the display area or change in the display range.

Accordingly, the object of the present invention is, even in case overall size of an area which becomes a target for display is larger than a display area of a display device, to provide a relationship information display device, a method and a program which enable display of information of a required range by a simple operation.

### Means for Solving the Problems

A relationship information display device of the present invention includes: a relationship information generating means which, from relationship strength which is set in advance between one attention information selected in advance from a plurality of information which becomes a target to display relationship strength representing a degree of strength of mutual relationship, and one or more no-attention information which are information other than the attention information among the plurality of information, calculates distance between one or more of the no-attention information and the attention information by a predetermined method, and generates relationship strength information of the plurality of information including the distance calculated; a display area moving means which, in case the distance between the no-attention information and the attention information is included inside, based on directions via an input device and by increasing or decreasing simultaneously a maximum value and a minimum value of a display range which becomes a target which displays a degree of relationship strength of the no-attention information with the attention information, moves the display range; a display information generating means which, based on the distance between one or more of the no-attention information and the attention information, calculates display distance which is distance from an origin to a position which displays the no-attention information in a display area for displaying relationship information so that magnitude relationship of the distance does not change in the display distance either and so that a numerical value of the display distance is included in a predetermined fixed range irrespective of where the display range is; and a display control means which, in case the distance between the no-attention information and the attention information is included in the display range, controls so that a location on the display screen whose distance from the origin which is positioned at a fixed single point in the display area and represents a position of the attention information equals the display distance which the display information generating means calculated is assigned to the no-attention information, displays an identification mark specifying the no-attention information on an output device by superposing it on a figure representing an index of the distance from the origin, and controls to output the display area to the output device.

A relationship information display method of the present invention includes: from relationship strength which is set in advance between one attention information selected in advance from a plurality of information which becomes a target to display relationship strength representing a degree of strength of mutual relationship, and one or more no-attention information which are information other than the attention information among the plurality of information, calculating distance between one or more of the no-attention information and the attention information by a predetermined method; generating relationship strength information of the plurality of information including the distance calculated; in case the distance between the no-attention information and the attention information is included inside, based on directions via an input device and by increasing or decreasing simultaneously a maximum value and a minimum value of a display range which becomes a target which displays a degree of relationship strength of the no-attention information with the attention information, moving the display range; based on the distance between one or more of the no-attention information and the attention information, calculating display distance which is distance from an origin to a position which displays the no-attention information in a display area for displaying relationship information so that magnitude relationship of the distance does not change in the display distance either and so that a numerical value of the display distance is included in a predetermined fixed range irrespective of where the display range is; in case the distance between the no-attention information and the attention information is included in the display range, controlling so that a location on the display screen whose distance from the origin which is positioned at a fixed single point in the display area and represents a position of the attention information equals the display distance which the display information generating means calculated is assigned to the no-attention information; displaying an identification mark specifying the no-attention information on an output device by superposing it on a figure representing an index of the distance from the origin; and controlling to output the display area to the output device.

A relationship information display program of the present invention makes a computer execute: relationship information generating processing which, from relationship strength which is set in advance between one attention information selected in advance from a plurality of information which becomes a target to display relationship strength representing a degree of strength of mutual relationship, and one or more no-attention information which are information other than the attention information among the plurality of information, calculates distance between one or more of the no-attention information and the attention information by a predetermined method, and generates relationship strength information of the plurality of information including the distance calculated; display area moving processing which, in case the distance between the no-attention information and the attention information is included inside, based on directions via an input device and by increasing or decreasing simultaneously a maximum value and a minimum value of a display range which becomes a target which displays a degree of relationship strength of the no-attention information with the attention information, moves the display range; display information generating processing which, based on the distance between one or more of the no-attention information and the attention information, calculates display distance which is distance from an origin to a position which displays the no-attention information in a display area for displaying relationship information so that magnitude relationship of the distance docs not change in the display distance either and so that a numerical value of the display distance is included in a predetermined fixed range irrespective of where the display range is; and display control processing which, in case the distance between the no-attention information and the attention information is included in the display range, controls so that a location on the display screen whose distance from the origin which is positioned at a fixed single point in the display area and represents a position of the attention information equals the display distance which the display information generating means calculated is assigned to the no-attention information, displays an identification mark specifying the no-attention information on an output device by superposing it on a figure representing an index of the distance from the origin, and controls to output the display area to the output device.

### Effect of the Invention

As has been described above, in case a display area which displays a visualized expression is limited, the present invention can display in its display area information from different display range by a simple operation. Moreover, because changes in the display range are performed by fixing a position of attention information which serves as a reference, the positional relationship of each information displayed can be grasped easily. Also, changes of the display range are possible by a simple operation.

### BRIEF DESCRIPTION OF THE DRAWINGS

FIG. 1 A figure illustrating a structure of a relationship information display device according to the first exemplary embodiment.

FIG. 2 A flow chart showing operation of a relationship information display device of the first and the second exemplary embodiment.

FIG. 3 A figure illustrating a structure of a relationship information display device according to the second exemplary embodiment.

FIG. 4 A block diagram illustrating a structure of a relationship information display device of the third exemplary embodiment.

FIG. 5 An explanatory drawing showing an example of all the area of information space which becomes a target for display in the third exemplary embodiment.

FIG. 6 A relationship strength explanatory drawing illustrating relationship strength of information D1-D4.

FIG. 7 A figure showing an example of display of relationship information when changing a display range successively.

FIG. 8 A figure showing an example of display of relationship information when changing a display range successively.

FIG. 9 A figure showing an example of display of relationship information when changing a display range successively.

FIG. 10 A flow chart illustrating processing after a user inputs information which becomes a target for display until initial display is performed in the third exemplary embodiment.

FIG. 11 A flow chart illustrating processing of setting of screen setting information described in Step S206.

FIG. 12 A characteristics diagram showing an example of a characteristic curve which illustrates relationship between a display scaling factor and a radius vector of an icon in the first, the second and the third exemplary embodiment.

FIG. 13 A flow chart illustrating processing of display control by pressing a key after relationship strength of each information is displayed on a liquid crystal display initially in the third exemplary embodiment.

FIG. 14 A block diagram illustrating a structure of a relationship information display device in the first modification example of the third exemplary embodiment.

FIG. 15 A plan view illustrating an example of relationship information displayed in the first modification example of the third exemplary embodiment.

FIG. 16 A flow chart illustrating processing of control of background color of an icon in the first modification example of the third exemplary embodiment.

FIG. 17 A block diagram illustrating a structure of a relationship information display device in the second modification example of the third exemplary embodiment.

FIG. 18 A plan view illustrating an example of display of icons of three no-attention information D2, D3 and D4 in the second modification example of the third exemplary embodiment.

FIG. 19 An explanatory drawing of a shape of an icon in the second modification example of the third exemplary embodiment.

FIG. 20 A flow chart illustrating display processing of an icon in the second modification example of the third exemplary embodiment.

FIG. 21 A block diagram illustrating a structure of a relationship information display device in the third modification example of the third exemplary embodiment.

FIG. 22 A flow chart illustrating display processing of an icon in the third modification example of the third exemplary embodiment.

FIG. 23 A plan view illustrating an example of display of relationship information in the fourth modification example of the third exemplary embodiment.

FIG. 24 A plan view illustrating an example of display of relationship information in the fifth modification example of the third exemplary embodiment.

FIG. 25 An explanatory drawing showing an example of display of relationship information by the first related technology.

FIG. 26 An explanatory drawing illustrating relationship strength of information D01-D08 in the example of display of FIG. 25.

FIG. 27 A block diagram of a relationship information display device of other exemplary embodiment of the present invention.

FIG. 28 A block diagram of a relationship information display method of other exemplary embodiment of the present invention.

FIG. 29 A block diagram of a relationship information display program of other exemplary embodiment of the present invention.

### DESCRIPTION OF CODES

1, 1A, 10, 100, 100A, 100B, 100C Relationship information display device

2, 2A Relationship information generating section

3, 3A Display information generating section

4, 107 Display area moving section

5, 5A Display control unit

6 Input device

7 Output device

11 Display window setting means

12 Extracted information displaying means

13 Designated value increasing or decreasing means

14 Display erasing means

20 Relationship information display method

21 Attention information setting

22 Increasing or decreasing designation

23 Identification mark assignment

24 Display control

30 Relationship information display program

31 Attention information setting processing

32 Increasing or decreasing designation processing

33 Identification mark assignment processing.

34 Display control processing

101 CPU

102, 102A, 102B, 102C Memory

103, 103A, 103B, 103C Main control unit

104 Input/output device

105 Information arrangement section

106 Concave expression section

108 Information reducing section

111 Up and down keys

112 Liquid crystal display

121 Display screen

122 Circle

1312, 1313 or 1314 and 131 A2, 131A3, 131A4, 131B2, 131B3, 131B4, 131D3, 131D4, 131E3, 131E4, 131E5 Icon (identification mark)

301 Information brightness changing section

511 Straight line which pass the origin and a display position of no-attention information D3

512 Tangential line of circle 122 at point P

521, 522, 523, 524 Side of trapezoid

701 Information color changing section

702 Moving range regulating section

901, 911 Display area

912, 913 Radius of sector

D01, D1 Attention information

D02, D03, D04, D05, D06, D07, D2, D3, D4 No-attention information

P Point of intersection between straight line 511 and circle 122

r0102, r0103, r0107, r12, r13, r14 Radius vector length

θ0203, θ0407, θ23, θ24, θ34 Central angle

### Most Preferred Mode for Carrying Out the Invention

<The First Exemplary Embodiment>

Next, the first exemplary embodiment of the present invention will be described in detail with reference to drawings.

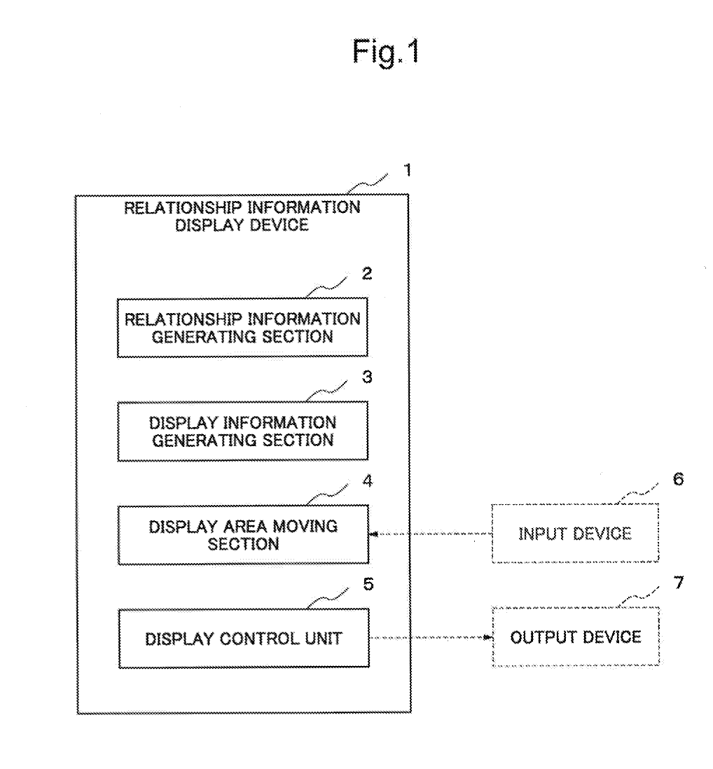

FIG. 1 is a figure illustrating a structure of a relationship information display device according to this exemplary embodiment.

Referring to FIG. 1, a relationship information display device I includes a relationship information generating section 2, a display information generating section 3, a display area moving section 4 and a display control unit 5.

The relationship information generating section 2 extracts, among a plurality of information which is a target to display relationship information inputted in advance, relationship strength between attention information selected singly in advance and no-attention information which is all of the other information. And the relationship information generating section 2 calculates distance between the attention information and each of the no-attention information from the extracted relationship strength based on a predetermined calculation method. Relationship information of this exemplary embodiment is distance representing a degree of the relationship strength between each of the no-attention information and the attention information.

The relationship strength is a numerical value which becomes an index representing strength of relationship between two of the information.

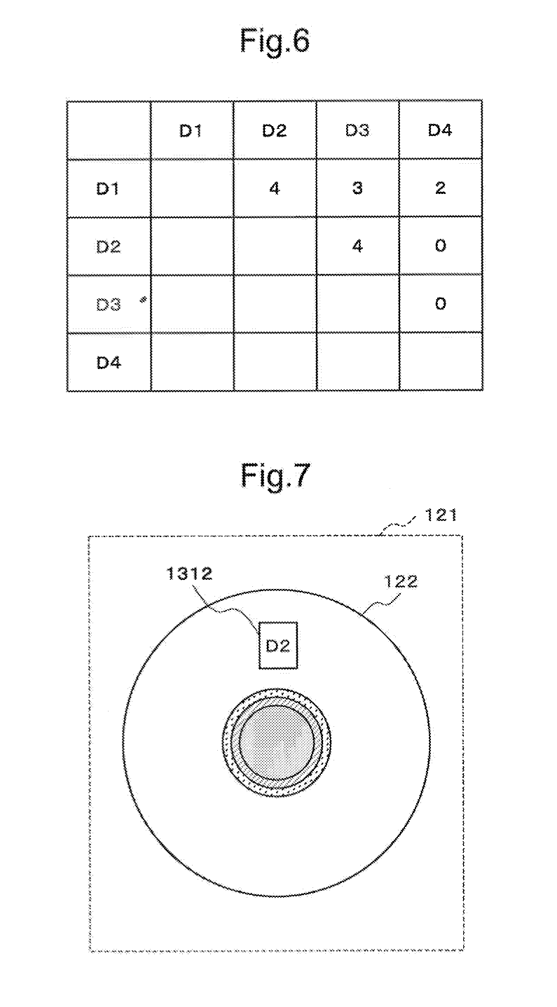

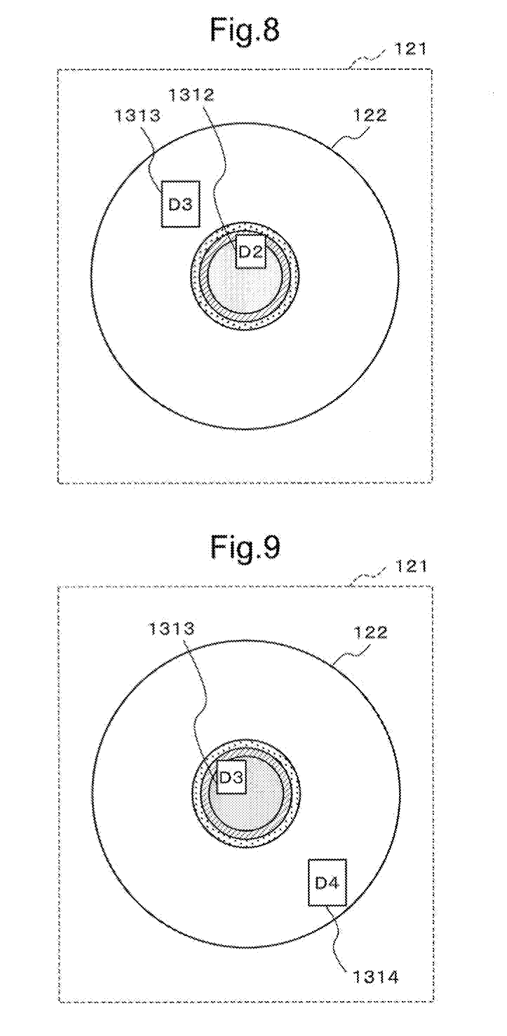

FIG. 6 is an example of relationship strength of information D1-D4. This example represents that the larger the numerical value is, the stronger the relationship strength between two of the information becomes. Also, it represents that between the information whose relationship strength is “0”, there is no relationship. Further, although the relationship strength is represented in integers in the example of FIG. 6, it may be represented in real numbers.

The distance calculated from the relationship strength is an index representing the relationship strength between the no-attention information and the attention information as closeness.

Calculation of the distance is performed between one information selected as the attention information in advance and all the no-attention information which is the information not selected as the attention information among the plurality of information. However, in case of the no-attention information which has no relationship with the attention information and whose relationship strength is “0”, distance is not calculated. Concerning the no-attention information for which distance is not calculated, display mentioned below will not be performed.

The calculation method which calculates distance from the relationship strength can use an existing method described, for example, in patent document 1. However, it will be made so that the stronger the relationship strength is and the larger the numerical value representing the relationship strength is, the smaller the distance becomes; and the weaker the relationship strength is and the smaller the numerical value representing the relationship strength is, the larger the distance becomes.

The display information generating section 3 receives data of the distance which the relationship information control unit 2 calculated and calculates display distance which is distance on a display screen which displays the relationship information by a predetermined calculation method. The display distance is the distance of a position which displays an identification mark representing no-attention information from an origin on the display screen. The identification mark will be described below. The origin is a fixed single point on the display screen which displays the relationship information, and represents a position of the attention information. The display distance which is the distance from the origin on the display screen to the position of the no-attention information represents a degree of the relationship strength between the attention information and the no-attention information. It is supposed that magnitude relationship of the distance is also held in the display distance calculated from the distance. That is, in case distance of certain information (suppose information 1) is larger than distance of other information (suppose information 2), it is supposed that display distance calculated from the distance of the information 1 becomes larger than display distance calculated from the distance of the information 2.

As mentioned below, no-attention information which becomes a target for display is limited to the no-attention information whose numerical value of the distance which the relationship information generating section 2 calculated is included in a range (hereinafter, referred to as display range) set in advance. Also, by user's operation, a maximum value and a minimum value of the display range change. However, the calculation method of the display distance is supposed such that, whichever numerical value the maximum value in the display range is, a maximum value of the display distance calculated from the maximum value of the display range will be a predetermined numerical value set in advance. Similarly, it is supposed that, whichever numerical value the minimum value of the display range is, a minimum value of the display distance calculated from the minimum value of the display range will be a predetermined numerical value set in advance. Calculation of such display distance can be performed, for example, when display distance corresponding to distance L which the relationship information control unit 2 calculated is set to Ld, by proportional calculation in which the difference between Ld and the minimum value of the display distance is proportional to the difference between L and the minimum value of the display range.

The display information generating section 3 of this exemplary embodiment calculates the display distance whatever a numerical value the distance which the relationship information generating section 2 calculated is. And in case distance of certain no-attention information which the relationship information generating section 2 calculates is not included in the display range, the display control unit 5 mentioned below will make an identification mark of the no-attention information not displayed. However, in case distance of certain no-attention information is not included in the display range, the display information generating section 3 may be made not to calculate the display distance. Further, it can be made to configure so that only in case not distance which the relationship information generating section 2 calculates but display distance which the display information generating section 3 calculates is included in a predetermined range, the display control unit 5 mentioned below performs display.

The display area moving section 4 increases or decreases, by user's operation via an input device 6, the maximum value and the minimum value of the display range, by the same numerical value and simultaneously. Hereinafter, to increase and decrease the maximum value and the minimum value of the display range simultaneously is described as movement of the display range. Also, when the maximum value and the minimum value of the display range are decreased simultaneously, the display range approaches the origin. Also, when the maximum value and the minimum value of the display range are increased simultaneously, the display range goes away from the origin. To decrease the maximum value and the minimum value of the display range simultaneously and move the display range in the direction approaching the origin is described as movement in decreasing direction. Also, to increase the maximum value and the minimum value of the display range simultaneously and move the display range in the direction going away from the origin is described as movement in increasing direction.

Also when the display area moving section 4 moves the display range, a position of no-attention information in the display range changes, and a display distance of the no-attention information also changes. As a result, on a display area mentioned below, positions of all of the displayed no-attention information change. As a result, the display area looks as if it is moving

The input device 6 can be an input device such as a cross key including a key which directs direction. As the input device 6, for example, a remote controller of a television, a key of a cellular phone, a keyboard connected to a computer and so on can be used. The input device 6 is not limited to these examples, and may be other input devices. A user directs movement direction of the display range by pressing a key associated with specific direction. For example, suppose pressing of an up key is directions of movement of the display range in the direction toward the origin. Also, suppose pressing of a down key is directions of movement of the display range in the direction going away from the origin.

Also, the user can direct an increasing amount or a decreasing amount of the maximum value and the minimum value of the display range by, for example, a number of pressing of the key or time of pressing of the key. For example, suppose the up key is the key to direct to decrease and the down key, to increase. In this case, when the user presses the up key, the display area moving section 4 makes both of the minimum value and the maximum value of the display range decrease simultaneously by a predetermined numerical value. When the user presses the down key, the display area moving section 4 makes both of the minimum value and the maximum value of the display range increase simultaneously by a predetermined numerical value. Also, each time pressing of the key by the user continues for a predetermined time from the time of start of pressing the key or the time of last change of the display range, the minimum value and the maximum value of the display range may be increased or decreased by a predetermined numerical value.

Further, operation for directing increase or decrease of the maximum value and the minimum value of the display range is not limited to pressing of a direction key. As far as it can direct to increase or to decrease the maximum value and the minimum value of the display range, the operation may be other operation.

The display control unit 5 fixes a single point corresponding to the attention area, makes it the origin on the display screen which is outputted to an output device, and performs display control of a figure which becomes an index of the distance from the origin on the display screen. The display screen indicates the whole screen displayed on the output device 7 such as a display. The display control unit 5 further displays identification marks corresponding to all the no-attention information which has relationship with the attention information and whose distance which the relationship information generating section 2 calculated is included in the display range at positions whose distance from the origin becomes the display distance corresponding to the no-attention information calculated by the display area calculating section 4. The position which displays the identification mark may be a position whose distance from the origin is the display distance mentioned above, and the direction against the origin may be decided according to an arbitrary standard. The display control unit 5 outputs the display screen to the output device 7 which superposed and displayed the identification marks corresponding to all the no-attention information which have relationship with the attention information on a figure which become an index of the distance from the origin. The output device 7 is, for example, a display.

The figure which becomes an index of the distance may be one by which the distance from the origin can be known as an aim. The figure which becomes an index of the distance can be made, for example, one or more circles with the origin as a center. Hereinafter, an area with a possibility that an identification mark is displayed will be called the display area. It is enough to display the circle which becomes an index of the distance only in the display area. Also, by the circle, the range of the display area can be shown. In this case, a radius of the circle of the outermost circumference is made the display distance of the case where the distance which the relationship information generating section 2 calculated is the maximum value of the display range. Also, a radius of the circle of the innermost circumference is made the display distance of the case where the distance which the relationship information generating section 2 calculated is the minimum value of the display range. An area surrounded by the circle of the outermost circumference and the circle of the innermost circumference is the display area. Further, color and brightness of the display area may be changed continuously, for example, according to the display distance. Also, inside of a plurality of areas which are divided by figures which become an index of the distance may be made different colors or different brightness respectively.

An identification mark is a character, a symbol, a figure, or their combination which is capable of specifying the no-attention information corresponding to the identification mark. As the identification mark, for example, a character string representing a name of the no-attention information surrounded by a rectangle can be mentioned. Hereinafter, the identification mark will also be described as an icon.

Next, operation of the relationship information display device according to this exemplary embodiment will be described in detail with reference to drawings.

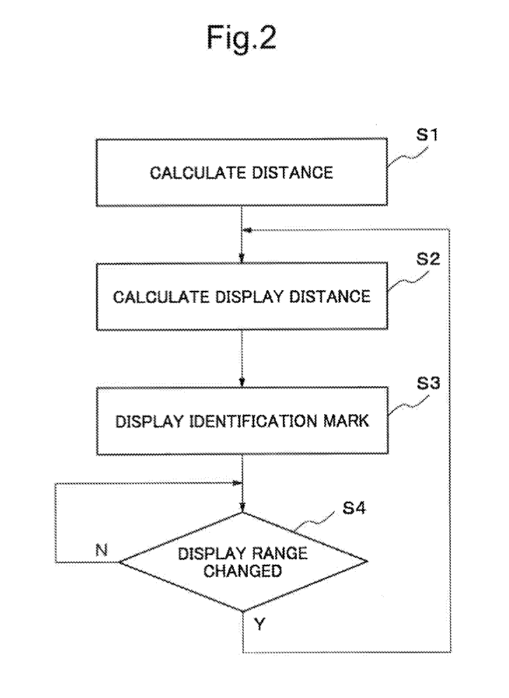

FIG. 2 is a flow chart illustrating operation of the relationship information display device 1 of this exemplary embodiment.

Referring to FIG. 2, first, from the relationship strength between one attention information and all the other no-attention information, the relationship information generating section 2 calculates the distance representing the strength of the relationship strength between the attention information and all of the no-attention information (Step S1). The relationship strength between the information is inputted in advance. The attention information is the information which is selected singly in advance from a plurality of information which becomes a target to display the relationship information. The no-attention information is all the information which is not selected among a plurality of information which becomes a target to display the relationship information. Calculation of the distance is performed respectively between the attention information and all of the no-attention information. However, the relationship information generating section 2 does not calculate the distance of the no-attention information which has no relationship with the attention information.

Next, the display information generating section 3 receives data of the distance between the attention information and each of the no-attention information calculated in Step S2 and calculates the display distance corresponding to each of the non-attention areas (Step S2). As described above, the display distance is the distance from the origin to the position which displays the no-attention information in case the attention information is arranged at the origin of the display screen to display the relationship strength between the information. The display information generating section 3 outputs data of the display distance to the display control unit 5.

Next, the display control unit 5 receives the data of the display distance and controls the output device 7 to display on the display screen a figure representing an index of the distance with the origin as a center, and by superposing on the figure, identification marks of each of the no-attention information (Step S3). The position which displays the identification mark of the no-attention information is made the position whose distance between the origin and the position which displays the identification mark of the no-attention information becomes the display distance calculated in Step S3.

In case the user changes the display range via the input device 6 (Step S4, Y), return to calculation of the display distance of Step S2.

As a result of the change in the display range, the identification mark of the no-attention information of which the position is not included in the display range any more disappears from the display area by the directions of the display control unit 5 in Step 3 after returning to Step S2 from Step S4, Y. That is, the relationship information display device 1 will make the identification mark of the no-attention information which goes off the display range disappear from the display area. Conversely, as a result of the change in the display range, the identification mark of the no-attention information of which the position is going to be included in the display range appears in the display area by the directions of the display control unit 5 in Step 3 after returning to Step S2 from Step S4, Y.

The relationship information display device of this exemplary embodiment can be realized by a computer and a program for controlling the computer.

Next, the effect of this exemplary embodiment will be described.

The relationship information display device of this exemplary embodiment includes the display information generating section, the display control unit and the display area moving section in its structure, and displays the identification mark of the no-attention information whose distance calculated from the relationship strength between the attention information is included in a predetermined range which can be changed by the user's operation. By this, in case the size of the display screen for displaying visualized expression of the relationship strength is limited, this exemplary embodiment has the effect to be able to display on the display screen the information of the various display ranges which the user designated.

Also, according to this exemplary embodiment, even if the display range is changed, while fixing the position which serves as the reference associated with the attention information, the identification mark of the no-attention information is displayed at a position of which the distance from the position which serves as the reference becomes the distance calculated based on the relationship strength between the attention information and the no-attention information. By this, this exemplary embodiment has the effect to be able to grasp easily the relationship strength which is associated with the positional relationship of each of the information displayed.

Also, according to this exemplary embodiment, in case the distance which is associated with the no-attention information is not included in a predetermined range, the identification mark of the no-attention information is not displayed. By this, this exemplary embodiment has the effect that a large number of identification marks will not be displayed at a position close to the reference position which is associated with the attention information and concise display becomes possible.

Also, according to this exemplary embodiment, changes in the display range are made by the user by directing the direction to which to change the display range. By this, this exemplary embodiment has the effect to be able to perform changes in the display range by a simple operation.

<The Second Exemplary Embodiment>

Next, the second exemplary embodiment will be described in detail with reference to drawings.

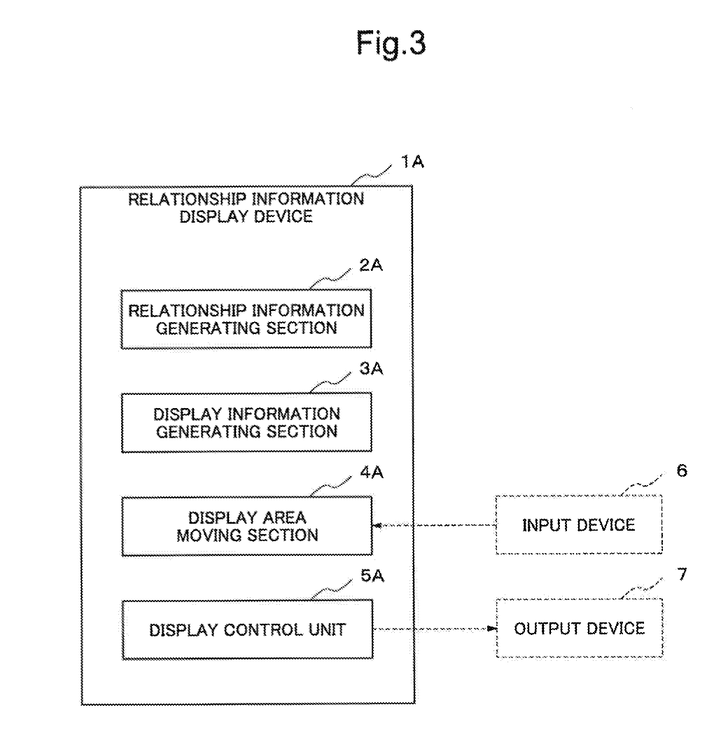

FIG. 3 is a figure illustrating a structure of this exemplary embodiment.

Referring to FIG. 3, a relationship information display device 1A of this exemplary embodiment includes a relationship information generating section 2A, a display information generating section 3A, the display area moving section 4 and a display control unit 5A. Because the display area moving section 4 is same as the display area moving section 4 of the first example, its description will be omitted. Hereinafter, description will be made centering on a point of difference between this exemplary embodiment and the first exemplary embodiment.

The relationship information generating section 2A calculates, similar to the relationship information generating section 2 in the first exemplary embodiment, distance between the attention information and each of the no-attention information from the relationship strength between the attention information selected singly in advance among a plurality of information for display and the no-attention information which is all of the other information based on a predetermined calculation method. However, the distance of the no-attention information which has no relationship with the attention information is not calculated.

The relationship information generating section 2A further determines direction of each of the no-attention information by a predetermined method so that angle which the directions of two different no-attention information form represents a degree of the relationship strength between the no-attention information. The direction of the no-attention information means the direction of a display position of the no-attention information with an origin as a center. The direction of the no-attention information can be expressed by the angle with a predetermined direction on the display screen serving as a reference. The relationship information generating section 2A makes the angle which the directions of each of the no-attention information form, for example, within a range from 0 degree to 180 degrees, such that the stronger the relationship strength is, the smaller the angle is, and the smaller the relationship strength is, the larger the angle is. The relationship information generating section 2A performs calculation of the angle for a combination of all the no-attention information. The direction of each of the no-attention information is arbitrary as far as the angle which the directions of each of the no-attention information form is based on the relationship strength among the corresponding no-attention information. Accordingly, for example, the direction of the no-attention information of which the relationship strength with the attention information is largest is decided first, and the direction of other no-attention information may be determined based on the direction which is decided first. However, the direction of the no-attention information which has no relationship with the attention information is not calculated.

The relationship information generating section 2A outputs data of the calculated distance and data which shows the direction of the no-attention information determined by a predetermined method to the display information generating section 3A.

The relationship information of this exemplary embodiment is the distance representing a degree of the relationship strength between each of the no-attention information and the attention information, and the direction to display a degree of the relationship strength among the no-attention information.

The display information generating section 3A calculates, similar to the display information generating section 3 of the first exemplary embodiment, from the distance that the relationship information control unit 2A calculated, display distance which is the distance on the display screen which displays the relationship information.

It can be structured such that the display information generating section 3A calculates display information irrespective of the distance which the relationship information generating section 2A calculates, and in case the display distance is not included in a display range set in advance, the display control unit 5A which is described below docs not perform display. Or, in case the distance which the relationship information generating section 2A calculates is not included in the display range set in advance, the display information generating section 3A may be made not to calculate the display distance.

Further, the display information generating section 3A determines the display position of each of the no-attention information based on the calculated display distance and the direction which the relationship information generating section 2A determined, and outputs the display position to the display control unit 5A as data. The display position is represented by the data of a polar coordinate determined by the display distance and the direction mentioned above.

The display control unit 5A fixes on the display screen displayed to the output device a single point corresponding to the attention area, makes it the origin, and displays on the display screen one or more circles which becomes an index of the distance from the origin and with the origin as a center. Partial area on the display screen divided by one or more circles mentioned above may be displayed by changing brightness for each partial area, for example, such that the closer the area is to the center of the circle, the darker. Also, it is possible to change color according to the distance from the origin, or change color for each of the partial area.

The display control unit 5A further displays an identification mark corresponding to the no-attention information, by superposing it on the figure mentioned above which becomes an index of the distance from the origin, on the display screen at the display position of the no-attention information which the display information generating section 3A calculated. The no-attention information of which the display control unit 5A displays the identification mark is all the no-attention information which has relationship with the attention information and whose distance which the relationship information generating section 2A calculated is included in the display range. The display control unit 5A outputs the display screen which displays the figure which becomes an index of the distance and the identification mark to the output device 7.

The figure which becomes an index of the distance can be made, for example, one or more circles which become an aim of the distance on the display screen from the origin and with the origin as a center. It is enough that the circles which become an index of the distance are displayed only in the display area. Also, by a circle, it is possible to show the range of the display area. In this case, the radius of the circle of the outermost circumference is made the display distance of the case where the distance which, the display information generating section 3 calculated is a maximum value in the display range. Also, the radius of the circle of the innermost circumference is made the display distance of the case where the distance which the display information generating section 3 calculated is a minimum value in the display range. The area surrounded by the circle of the outermost circumference and the circle of the innermost circumference is the display area. The position of the identification mark of the no-attention information which the display control unit 5A displays is included in the display area on the display screen.

Also, the color and the brightness in the display area may be changed, for example, according to the display distance continuously. Also, inside of a plurality of areas which arc divided by the figures which become an index of the distance may be made different colors or different brightness respectively.

The identification mark is, for example, a character string a symbol and so on for specifying the corresponding no-attention information surrounded by a rectangle. Size of the identification mark can be changed according to the display distance from the origin to the identification mark. In case the size of the identification mark is reduced according to the display distance, for example, a display scaling factor according to the display distance from the origin is decided in advance, and the display control unit 5A may reduce the size of the identification mark by the display scaling factor according to the distance between the display position of the identification mark and the origin, and display it.

A numerical value of the display scaling factor for deciding the size of the identification mark to be displayed can be made, for example, 1 at the outermost circumference of the display area, and inside of the outermost circumference, a numerical value proportional to the display distance from the origin. Also, it is possible, for example, in the area outside of a predetermined circle included between the outermost circumference and the innermost circumference of the display area, the display scaling factor is made 1, and in the area inside of the predetermined circle, the display scaling factor can be set to a numerical value proportional to the display distance from the origin. Further, by deciding a characteristic curve representing relationship between the distance from the origin and the display scaling factor in advance, the display scaling factor may be obtained from the display position of the identification mark based on the characteristic curve. Further, the characteristic curve may be represented by a broken line, not a curve.

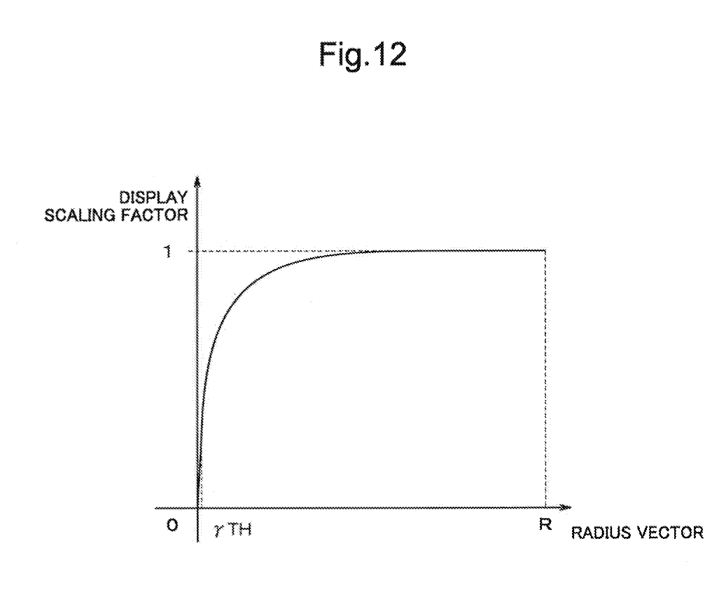

FIG. 12 is an example of a characteristic curve illustrating relationship between the distance and the display scaling factor. A radius vector described in FIG. 12 corresponds to the display distance mentioned above. Also, the maximum value of the display distance before the display scaling factor is multiplied corresponds to R and the minimum value corresponds to rTH.

Also, the color and the brightness of background of an identification mark can be changed according to the distance from the origin to the identification mark. For example, the background of the identification mark may be made same brightness and color as the partial area in which the identification mark is positioned. Further, the background of the identification mark is, of the identification mark, an area other than a character string, a symbol and so on which specifies the information to which the identification mark corresponds. Hereinafter, “brightness of identification mark” means the brightness of the background of the identification mark. Also, “color of identification mark” means the color of the background of the identification mark.

FIG. 7, FIG. 8 and FIG. 9 are examples of display which displayed the relationship strength among the information D1 to D4 shown in FIG. 6 with the information D1 as the attention information, and which changed the display range successively in the direction which goes away from the origin.

In FIG. 7, only an identification mark 1312 of the information D2 appears on the display screen. Also, concerning the partial areas which are divided by a plurality of circles which show an index of the distance, the closer the area is to a center of the circle, the darker.

FIG. 8 is an example of display which changed the display range in the direction which goes away from the origin. The identification mark of the information D2 moves to the position closer to the center of the circle, and an identification mark of the information D3 appears on the display screen. The information D3 has smaller relationship strength with the information D1 than the relationship strength of the information D2. Examples of display in FIG. 7, FIG. 8 and FIG. 9 display the identification mark, in case a position of the identification mark is inside of a white area of a circle 122, by reducing it according to the display scaling factor of a numerical value proportional to the distance from the center of the circle. Also, in these figures, the display scaling factor of an identification mark in case the position of the identification mark is in the white area of the circle 122 is 1.

FIG. 9 is an example of display which further changed the display area in the direction which goes away from the origin. The identification mark of the information D3 moves to the position closer to the center of the circle, and an identification mark of the information D4 appears on the display screen. The information D4 has smaller relationship strength with the information D1 than the information strength of the information D3.

Next, operation of this exemplary embodiment will be described with reference to drawings.

Although the operation of this exemplary embodiment is a little bit different from the operation of the first exemplary embodiment shown in FIG. 2, it will described using FIG. 2 for convenience of description.

Referring to FIG. 2, first, the relationship information generating section 2A generates relationship information (Step S1). The relationship information of this exemplary embodiment is data of distance representing a degree of the relationship strength between each of the no-attention information and the attention information and data which shows direction representing a degree of the relationship strength among the no-attention information.

Next, the display information generating section 3A calculates, from the distance of each of the no-attention information calculated in Step S1 and based on the display range set in advance, display distance which is the distance from the origin to the position which displays an identification mark of each of the no-attention information, and outputs it to the display control unit 5A (Step S2). From the display distance calculated in Step S2 and the direction determined in Step S1, a coordinate on a display screen of the position which displays each of the identification marks is decided.

Next, the display control unit 5A controls the output device 7, based on the calculated display distance, so that a circle which will be an index of the distance from the origin and an identification mark of each of the no-attention information may be displayed on the display screen (Step S3). However, the no-attention information for which the identification mark is displayed is limited to those of which the distance calculated in Step S1 is included in the display range. The center of the circle is the origin set at a single point on the display screen. Also a position which displays the identification mark is the position with the coordinate calculated in Step S2. The display control unit 5A outputs the information on the display screen to the output device 7.

In case the user changes the display range via the input device 6 (Step S4, Y), return to Step S2.

Next, the effect of this exemplary embodiment will be described. This exemplary embodiment has, in addition to the effect of the first exemplary embodiment, the following effects.

The relationship information display device of this exemplary embodiment includes the relationship information generating section and the display information generating section, and from the relationship strength between each of the no-attention information, calculates an angle of the direction where the identification mark of two of the no-attention information is displayed. By the calculated angle, with the origin which is associated with the attention information as the center, it is determined in which direction to display the identification mark of each of the no-attention information. By this, this exemplary embodiment has the effect to be able to display the relationship strength between the no-attention information in addition to the relationship strength between the attention information and the no-attention information.

<The Third Exemplary Embodiment>

Next, the third exemplary embodiment of the present invention will be described.

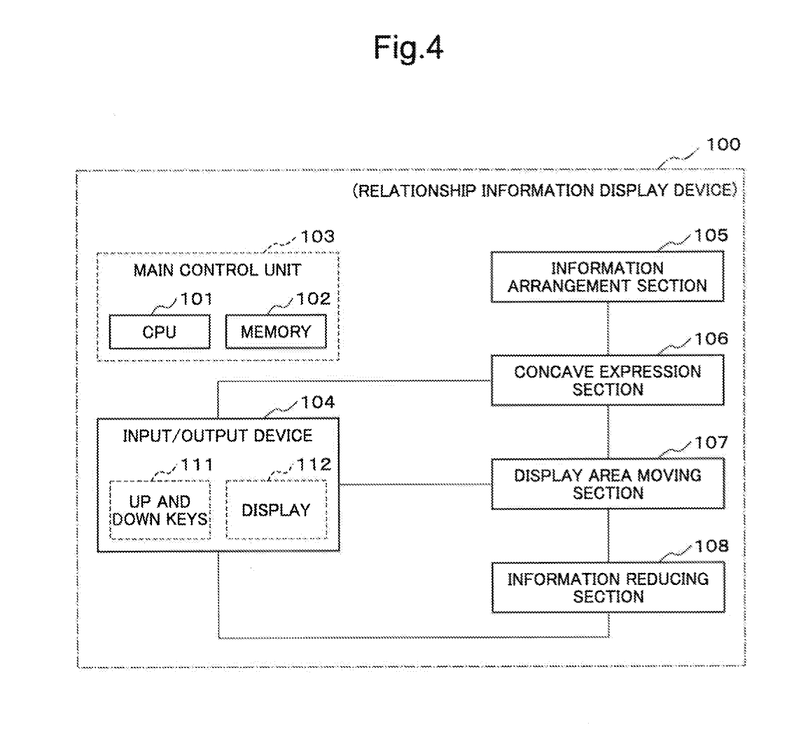

FIG. 4 outlines a structure of a relationship information display device according to this exemplary embodiment. A relationship information display device 100 of this exemplary embodiment includes a main control unit 103 including CPU (Central Processing Unit) 101 and a memory 102 which stores at least a predetermined control program in its part. The main control unit 103 controls an input/output device 104, an information arrangement section 105, a concave expression section 106, a display area moving section 107 and an information reducing section 108 in the device. Also the main control unit 103 can, by CPU 101 executing a control program. realize at least part of each of these sections in the device based on software.

Here, the input/output device 104 includes an input device such as a remote controller or a key panel being arranged a key switch which inputs user's operational information and a visual display device. According to this embodiment, as the input device which inputs the operational information, up and down keys 111 which direct upward direction and downward direction is included. Also, a liquid crystal display 112 is included as the display device. The liquid crystal displays 112 may be other displays such as an organic EL (organic electroluminescence) display.

The information arrangement section 105 calculates a coordinate of the no-attention information from the relationship strength between the inputted information, and based on the calculated numerical value, arranges various information on the polar coordinate plane. Concretely, the information arrangement section 105 makes the position of the attention information a center (origin) of the polar coordinate system. Also, the information arrangement section 105 arranges each of the no-attention information so that a radius vector calculated from the relationship strength as a degree representing the strength of the relationship between the attention information and the no-attention information by a predetermined calculation method will be the distance between the attention information and the no-attention information. Here, “radius vector” means, when a point on the plane is represented by a polar coordinate, length between the point and the origin of the polar coordinate. In relation to the first and the second exemplary embodiment, the radius vector corresponds to “distance” which the relationship information generating section 2 or the relationship information generating section 2A calculates.

In case a plurality of no-attention information exist, based on the relationship strength between the no-attention information and by deciding an angle which straight lines connecting the display positions of the no-attention information and the origin form respectively, the information arrangement section 105 determines the arrangement direction of the no-attention information with the origin as a center. Determination of the angle from the relationship strength may be performed by an arbitrary existing method. This angle will be called as a central angle in this specification. As far as the user can distinguish, a display form which illustrates the positional relationship between the attention information and the no-attention information may be any display form. For example, by displaying an identification mark such as a character, a figure, an icon or a thumbnail as a reduced image which specifics the information of the attention information and so on at the arrangement position of each of the information, the positional relationship among each of the information can be illustrated In this exemplary embodiment, the identification mark for specifying the information such as a character, a figure, an icon or a thumbnail will be called collectively as an icon. The icon corresponds to “identification mark” in the first and the second exemplary embodiment.

The concave expression section 106 draws a circle with the origin of the polar coordinate plane as a center on the display screen which is not shown and included in the input/output device 104, and makes inside of this circle a display area for the attention information and the no-attention information. Further, within an area less than a radius vector of a predetermined length from the origin, by performing display using gradation which makes brightness the lower, the closer to the center, an expression form which increases depth toward the origin is adopted. The gradation may adopt gradation representation illustrating a step-by-step intensity change or may adopt gradation representation illustrating a continuous intensity change.

The display area moving section 107 moves, based on directions from the user via the input/output device 104, in the information space, the display range which becomes a target for display. The information which exists in the area included in the display range in the information space is the target for display. The display range is supposed to be a ring-like area in the information space where the distance from the origin is included within the range of constant-breadth. Movement of the display range is to increase or decrease the distance from the origin to the innermost circumference and to the outermost circumference of the display range so that the difference between the distance from the origin to the innermost circumference and the distance from the origin to the outermost circumference of the display range will always be a fixed numerical value which is set in advance. When the display range moves and shifts to a different area, a change in a relative position of the information in the display range or replacement of the information included in the display range will take place. Accordingly, a change of a position or replacement of an icon displayed on the liquid crystal display 112 will take place.

The input/output device 104 includes the up and down keys 111. The up and down keys 111 includes an up key and a down key. The user directs movement directions of the display range by pressing a key associated with the specific direction. For example, suppose pressing of the up key is the directions of the movement of the display range in the direction toward the origin. Also, suppose pressing of the down key is the directions of the movement of the display range in the direction going away from the origin. Also, the user can direct the movement distance by, for example, the number of pressing of the key or the time of pressing of the key. In this case, each time the key is pressed, the display rang is supposed to move only for a predetermined distance. Also, each time a predetermined time elapses from starting of pressing of the key or the last movement, the display range is supposed to move only for a predetermined distance. The directions of an amount of movement can also be performed by other method as far as it is a method which can direct an amount or a number. Hereinafter, operation amount of the key for directing the movement distance such as the number of pressing of the key or the time of pressing of the key is called a pressed amount of the key.

For example, in case the user continually directs the movement of the display range toward outside, in the direction of the radius vector, the display range moves to the position where the information of which the position in the information space was outside of the display range in the direction of the radius vector at first will become included inside. When directions of the movement of the display range toward outside, in the direction of the radius vector, further continue, the display range moves from the position of the information toward outside, in the direction of the radius vector.

Although detailed description will be made below, in case the display range moves from a display position of certain information in the information space in the direction of the radius vector from inside toward outside as mentioned above, the icon of the information displayed on the liquid crystal display 112 moves as follows.

In the information space, when the information is positioned outside of the display range, the icon of the information is not displayed on the liquid crystal display 112. In the information space, when the display range moves to the position where the position of the information will be at the outermost circumference of the display range, the icon of the information appears at the outermost circumference of the display area displayed on the liquid crystal display 112. When the display range moves toward outside, in the direction of the radius vector, with the state the position of the information being included inside, the icon of the information moves from the circumference of the display area displayed on the liquid crystal display 112 toward inside. In the information space, when the display range moves to the position where the position of the information will be at the innermost circumference of the display range, the identification mark of the information moves to the innermost circumference of the display area displayed on the liquid crystal display 112. In the information space, when the display range moves outside of the position of the information, the identification mark of the information will not be displayed in the display area displayed on the liquid crystal display 112 any more.

For the display area moving section 107 to move the icon displayed in the display area in the direction of the center by moving the display range in the information space toward outside, in the direction of the radius vector, will be described as to move the display area toward outside, in the direction of the radius vector. Also, to move the icon displayed in the display area in the direction which goes away from the center by moving the display range in the information space toward inside, in the reverse direction of the radius vector, will be described as to move the display area toward inside, in the reverse direction of the radius vector.

Because the movement of the display range described above is performed successively by each predetermined distance, the position of the identification mark in the display area on the liquid crystal display 112 also moves successively by the distance according to the amount of movement of the display range. Accordingly, in case the display range moves from inside toward outside, in the direction of the radius vector, the identification mark in the display area on the liquid crystal display 112 looks to move from outside in the direction toward the origin, and disappear at a location with predetermined distance from the origin. Hereinafter, to move the displayed identification mark in the display area displayed on the liquid crystal display 112 by moving the display range in the information space by a key operation will be described as to “move display area”. Also, to move the displayed identification mark in the direction which goes away from the origin by a key operation will be described as to move the display area toward outside, in the direction of the radius vector. Similarly, to move the displayed identification mark in the direction which approaches the origin by a key operation will be described as to move the display area toward inside, in the reverse direction of the radius vector.

The information reducing section 108 performs, for the information arranged in the display area, reduced display such that the more inside in the direction of the radius vector it is located, the smaller the unit area will be displayed. At this time, the reduction percentage of the information arranged on the inside boundary of the display area, the boundary located in the reverse direction of the radius vector, is made maximum. It is supposed that the information arranged on the outside boundary, the boundary located in the direction of the radius vector, will not be reduced. Further, inside of the display area in the direction of the radius vector means the side in the display area closer to the origin. Also, outside of the display area in the direction of the radius vector means the side in the display area farther from the origin.

The relationship information display device 100 of this embodiment displays, by taking the structure as stated above, in ease the display range moves in the direction going away from the origin, such that the icon of the no-attention information in the display area moves from the peripheral part toward inside, in the reverse direction of the radius vector, while reducing its size. And the relationship information display devices 100 realizes an expression in which, by not displaying the icon whose distance to the origin is lower than a constant value, the icon of the no-attention information which gathered in the vicinity of the center of the display area and overflowed disappear as if falling toward the back of the screen. Similarly, in case the display range moves in the direction approaching the origin, the icon of the no-attention information in the display area is displayed such that it moves from peripheral part toward outside, in the direction of the radius vector, while expanding its size. As a result, the direction of the up and down keys 111 which the user operates and the movement direction which shows the change in the arrangement state of each icon accompanied by the change (movement) of the display area on the liquid crystal display 112 agree visually. Accordingly, the user can, without being conscious of the change in the display area in particular, search all the area of the information space as the target and grasp the relationship strength of the attention information and the no-attention information easily.

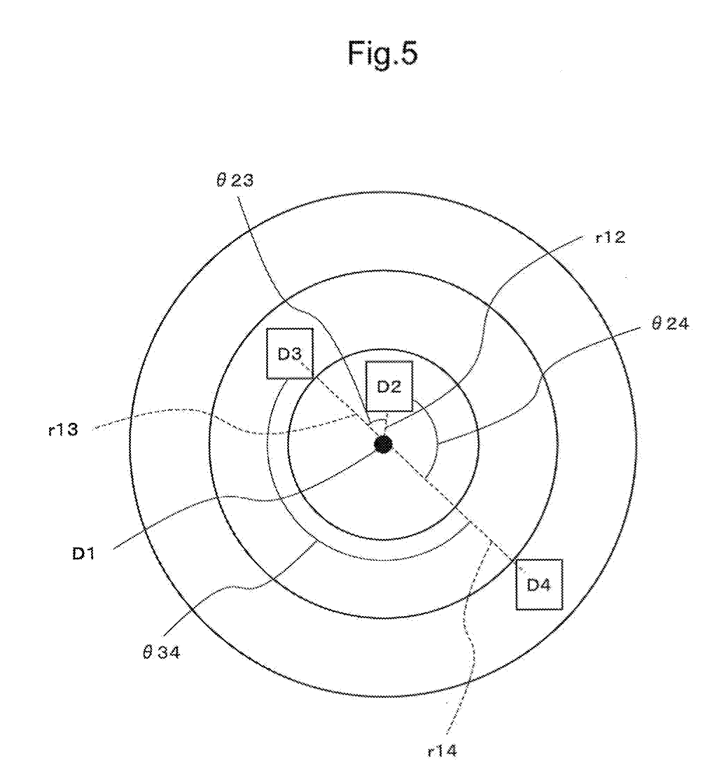

FIG. 5 shows an example of all the area of the information space which becomes the target for display in this embodiment. In the information space, the attention information D1 as the specific information which should be paid attention and the no-attention information D2-D4 which become a target for comparison as the information other than this are arranged by the polar coordinate system according to the relationship strength. In this example, the attention information D1 is arranged at the origin O of the polar coordinate system. The radius vector lengths r12-r14 represent the relationship strength between the attention information D1 and the no-attention information D2-D4 respectively. The radius vector length represents that the shorter the length is, the stronger the relationship strength between the attention information and the corresponding no-attention information is. Also, the mutual relationship strength among the no-attention information D2-D4 is expressed by their central angles θ23, θ24 and θ34 approximately. The central angle represents that the smaller the angle is, the stronger the relationship strength of two of the corresponding no-attention information is.

By illustrating the relationship strength between the no-attention information by the arrangement of the no-attention information in the direction of circumference, the relationship strength between the attention information and the no-attention information and the relationship strength among the no-attention information can be displayed simultaneously. Also, the maximum degree of angle of a central angle is set to 180 degrees. Accordingly, for example, the angle which the no-attention information D2 and the no-attention information D3 form is the central angle θ23 as shown in FIG. 5, and is not the angle which deduced the central angle θ23 from 360 degrees and is larger than 180 degrees.

FIG. 6 illustrates the relationship strength of the information D1-D4 in the example of display shown in FIG. 5. The numerical value representing the relationship strength represents that the larger the numerical value is, the stronger the relationship strength is. This explanatory drawing of the relationship strength arranged the relationship strength among each of the information D1-D4 in a matrix form. The numerical value of each of the elements represents the relationship strength between two of the information corresponding to the row and the column of the element. For example, the numerical value representing the relationship strength between the attention information D1 and the no-attention information D2 is “4”. Also, the numerical value representing the relationship strength between the no-attention information D2 and the no-attention information D4 is “0”. In FIG. 6, although the numerical values representing the relationship strength among each of the information D1-D4 are integers, they need not be integers necessarily. The relationship information can be displayed using any real numbers.

By the way, in the example shown in FIG. 6, the relationship strength of the no-attention information D2-D4 with the attention information D1 is represented in either of three integers: numerical values “4”, “3” and “2”. In case of this example, the relationship strength of the no-attention information D2-D4 with the attention information D1 can be expressed by the distance with three levels.

Looking at FIG. 5, the radius vector length r12 which is the distance between the attention information D1 and the no-attention information D2 is shorter than either of other radius vector lengths r13 and r14. This shows that the relationship strength of the attention information D1 and the no-attention information D2 is higher than either of the relationship strength of the attention information D1 with other no-attention information D3 and D4.

Also, looking at FIG. 5, because the radius vector length r13 is shorter next to the radius vector length r12, the relationship strength of the attention information D1 and the no-attention information D3 can be seen to be high in the second place. Further, because the radius vector length r14 is longest in FIG. 5, the relationship strength of the attention information D1 and the no-attention information D4 can be seen to be weakest among the relationship between three kinds of the no-attention information D2-D4 and the attention information D1. Although, the case where the radius vector length takes integers and changes step by step is described here, as has been described, the radius vector length is not limited to integers. Accordingly, the radius vector length or the relationship strength can be expressed by a continuous numerical value.

Next, the mutual relationship strength among the no-attention information D2-D4 in FIG. 5 and FIG. 6 will be described. As described above, the relationship strength of two of the no-attention information is represented by a central angle which the positions of two of the no-attention information and the origin form. Also, the stronger the relationship strength is, and the larger the numerical value representing the relationship strength is, the smaller the central angle becomes. In the example shown in FIG. 6, the numerical value representing the relationship strength of the no-attention information D2 and the no-attention information D3 is largest and “4”. For this reason, as shown in FIG. 5, the no-attention information D2 and the no-attention information D3 are arranged so that the central angle θ23 which the no-attention information D2 and the no-attention information D3 form will be smallest. Also the numerical values representing the relationship strength between the no-attention information D2 and the no-attention information D4 and between the no-attention information D3 and the no-attention information D4 are both “0”. For this reason, the no-attention information D2, D3 and D4 arc arranged so that the central angle θ24 which the no-attention information D2 and the no-attention information D4 form and the central angle θ34 which the no-attention information D3 and the no-attention information D4 form will be a large angle close to 180 degrees as much as possible.

FIG. 7, FIG. 8 and FIG. 9 show an example which displays on the screen successively the no-attention information included in the information space shown in FIG. 5 while moving the display range. Among them, FIG. 7 illustrates a screen displayed at the initial state on the liquid crystal display 112 of the relationship information display device 100 shown in FIG. 4. On a display screen 121, a circle 122 is drawn. The circle 122 is in gradation representation that the closer the center is approached, the lower the brightness of the color part is made. In FIGS. 7-9, although the gradation representation is expressed by the gradation of four levels, for example, the gradation representation such that the brightness becomes continuously lower in the direction of the center from a peripheral part of the circle 122 may be realized.

In this exemplary embodiment, description will be made by supposing that the color inside of the circle 122 or, the color of the background color which is inside of the icon and an area other than the character and so on which specifics the information corresponding to the icon are white, black or gray of a certain brightness (achromatic color) which can be represented only by the brightness. However, the color inside of the circle 122 or the background color of the icon mentioned above need not be achromatic necessarily. Further, in figures such as FIGS. 7-9, the brightness is expressed by the density of a black area.

FIG. 7 displays in the circle 122 an icon corresponding to the information included in part of the area among the whole information space. The state shown in FIG. 7 is supposed to be the initial state. Here, only the position of the no-attention information D2 among the no-attention information D2, D3 and D4 shown in FIG. 5 is displayed by a rectangular icon 1312 inside the circle 122. Also, the background color of the icon 1312 is the lightest color (white, for example) identical with the peripheral part of the circle 122. Inside the icon 1312, characters “D2” which show that the icon 1312 corresponds to the no-attention information D2 are displayed with the brightness or the color different from the background color.

In the initial state shown in FIG. 7, icons of other no-attention information D3 and D4 in FIG. 5 are not displayed inside the circle 122. Accordingly, the user cannot know the information having relationship with the no-attention information D3 and D4 by this display of the initial state.

In order to know the information having relationship with the no-attention information D3 and D4, the user operates the up and down keys 111 which is included in the input/output device 104 shown in FIG. 4 and moves the display area on the display screen 121. Here, the up key which is included in the up and down keys 111 is the key which directs the display area to move toward inside, in the reverse direction of the radius vector, that is, toward the center of the circle 122, and the down key is the key which directs the display area to move toward outside, in the direction of the radius vector, that is, in the direction to go away from the center of the circle 122.

When the user presses the down key for a predetermined amount in the initial state shown in FIG. 7, the display state will become as shown in FIG. 8. In this state, the display area in the circle 122 moves toward outside, in the direction of the radius vector, by the pressed amount of the down key. As a result, the icon 1312 representing the no-attention information D2 moves relatively in the direction of the center of the circle 122. Also, an icon 1313 representing the no-attention information D3 which existed outside of the display area of the circle 122 appears in the circle 122. Here, as the icon 1312 representing the no-attention information D2 approaches the vicinity of the origin, it is reduced and displayed by the information reducing section 108 shown in FIG. 4. The shape of the icon 1313 is a rectangle same as the icon 1312. Also, the background color of the icon 1313 is the lightest color (white, for example) identical with the peripheral part of the circle 122. Inside the icon 1313, characters “D3” which show that the icon 1313 corresponds to the no-attention information D3 are displayed with the brightness or the color different from the background color.

Suppose the user pressed the down key further from the display state shown in FIG. 8. Then, the display area moves toward outside, in the direction of the radius vector, by the pressed amount of the down key. As a result, an icon 1314 representing the no-attention information D4 which existed outside the display area of the circle 122 appears in the circle 122. Together with this, the icon 1313 which represents the no-attention information D3 which moved halfway in the circle 122 in FIG. 8 further moves in the direction toward the origin, and is reduced and displayed by the information reducing section 108. The icon 1314 also has a rectangular shape same as other icons 1312 and 1313. Also, the background color of the icon 1314 is the lightest color (white, for example) identical with the peripheral part of the circle 122. Inside the icon 1314, characters “D4” which show that the icon 1314 corresponds to the no-attention information D4 are displayed with the brightness or the color different from the background color.

On the other hand, the icon 1312 which represents the no-attention information D2 which is reduced and displayed in FIG. 8 approaches further in the direction toward the origin and goes off from the display area finally. As a result, the icon 1312 of the no-attention information D2 is not displayed any more in FIG. 9. When the user keeps pressing the down key further, the icons 1313 and 1314 of the no-attention information D3 and the no-attention information D4 also move in the direction toward the origin further. And, although not shown, at a certain point, the icon 1313 of the no-attention information D3 which is closer to the origin becomes not displayed any more before the icon 1314 of the no-attention information D4.

Display operation using the up and down keys 111 mentioned above can be performed reversibly. Accordingly, when the user operates the up key instead of the down key, the display state of FIG. 9 returns to the display state of FIG. 8, and further returns to the display state of FIG. 7. By operating the up key as stated above, for example, the icon 1313 of the no-attention information D3 which is reduced and displayed in FIG. 9 will, as the degree of the reduction in size by the information reducing section 108 becomes weaker, return to the original size as shown in FIG. 8. And, when the up key is operated further, the icon 1313 of the no-attention information D3 goes out to a non-display area outside the circle 122 and will not be displayed any more inside the circle 122 as shown in FIG. 7.

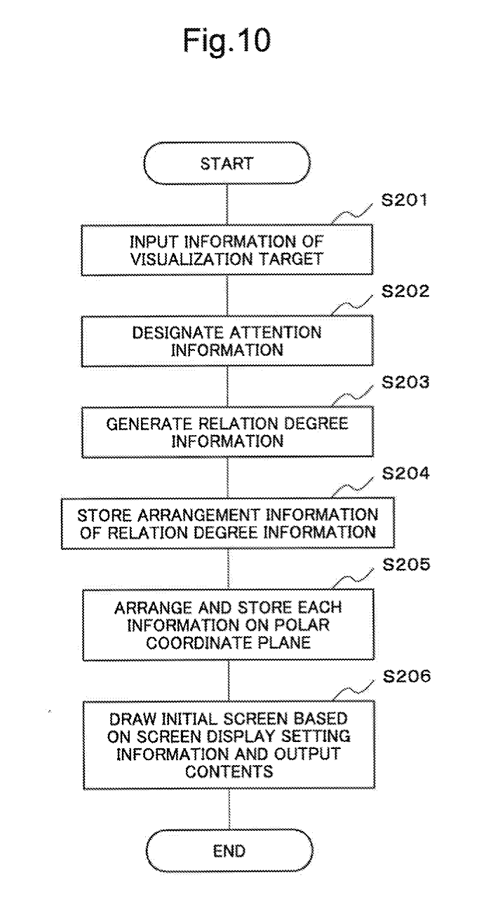

FIG. 10 illustrates processing in this embodiment after the user inputs the information which becomes the target for display until the initial display is performed.

First, the input/output device 104 of the relationship information display device 100 inputs the information of a visualization target (Step S201). This includes a plurality of information which becomes a visualization target and data representing the relationship strength of the information. Input of such information may be performed by the user's operation from the input device such as a keyboard which is not shown or such information may be sent to the relationship information display device 100 via a communication network which is not shown. Also, the input/output device 104 may read such information from a storage medium which is not shown.

When the information of a visualization target is inputted, directions to designate the attention information are displayed on the liquid crystal display 112 of the input/output device 104. The user designates the attention information from a plurality of information based on this (Step S202). Among the information of a visualization target, information other than the designated attention information will become the no-attention information. In place of designating the attention information, the no-attention information may be designated instead of the attention information or both of the attention information and the no-attention information may be designated.

When various information, the data representing the relationship strength of the information, and the information which divides the attention information and the no-attention information become complete, the information arrangement section 105 generates the relationship strength information corresponding to the relationship strength explanatory drawing representing the relationship strength of each of the information D1-D4 shown in FIG. 6 (Step S203). However, in case the information inputted in Step S201 is the information already created and representing the relationship strength information, processing of Step S202 and Step S203 is omitted. In either case, the information arrangement section 105 stores the relationship strength information in a storage area which is not shown (Step S204).

The concave expression section 106 stores in a storage area which is not shown the information which draws all the area of the information space on the polar coordinate plane as shown in FIG. 5 using the relationship strength information stored in this storage area (Step S205). At this time, the attention information D1 is arranged at the center of the circle (origin), and the no-attention information D2-D4 is stored with the contents as if drawn using the radius vector lengths r12-r14 and central angles θ23, θ24 and θ34. The whole of the drawing contents may not be displayed on the liquid crystal display 112.

The concave expression section 106 generates an image which is displayed actually from part of the stored drawing contents based on screen setting information described below and outputs the contents on the liquid crystal display 112 which is included in the input/output device 104 (Step S206). This image will be the one shown in FIG. 7. Also, in the image displayed on the liquid crystal display, the position corresponding to the attention information is supposed to be the center of the circle (origin). Also, the icon of the no-attention information is reduced and displayed according to the radius vector length of the corresponding no-attention information. In case the display position of the icon is close to the center and goes off from the display area, the concave expression section 106 does not display the icon. Initial display processing shown in FIG. 10 ends at Step S206. The relationship information display device 100 waits for the operation of the up and down keys 111 by the user in the display state at the time Step S206 ended.

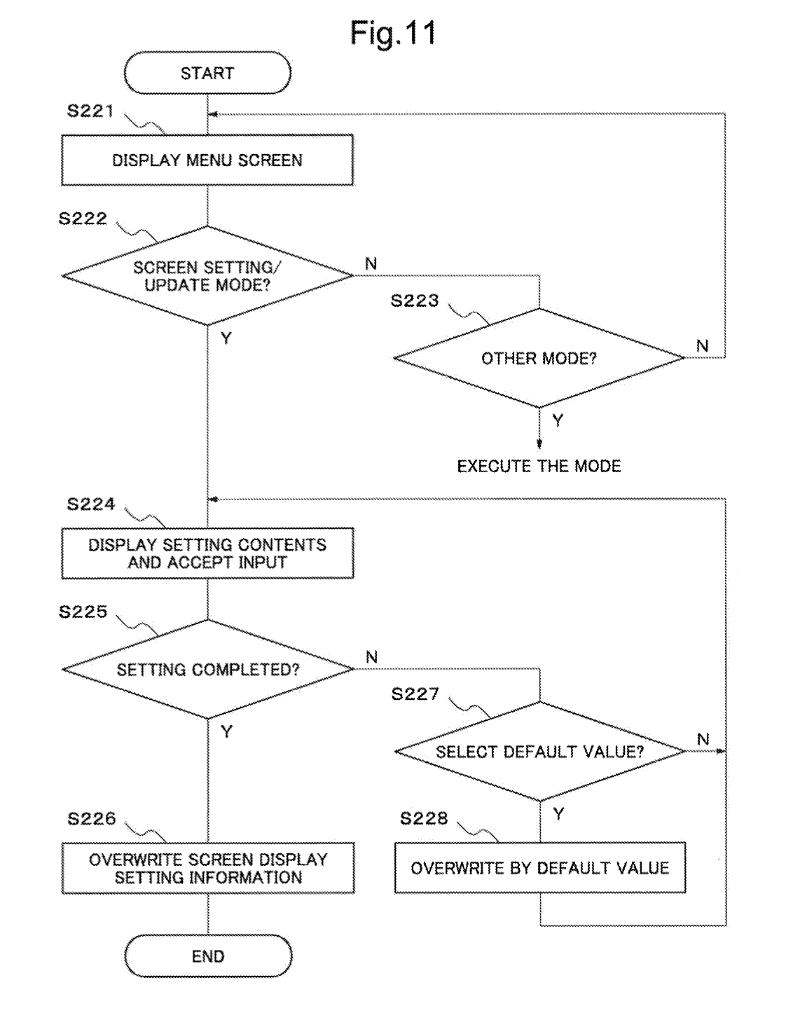

FIG. 11 is an example which illustrates the way of setting of the screen setting information described in Step S206. In cast the screen setting information is not set or the user wants to change conditions to illustrate the relationship strength of various information visually, the user sets or updates the screen setting information.

In the state the relationship information display device 100 displays a menu screen on the liquid crystal display 112 (Step S221), and in case the user selects “screen setting/update mode” from the displayed items (Step S222: Y), the user can set the screen setting information. Further, in case the user selects other item from the menu screen (Step S222: N, Step S223: Y), the relationship information display device 100 performs the operation corresponding to the item which the user selected.

In case the user selects “screen setting/update mode” in Step S222 (Step S222, Y), the relationship information display device 100 displays the present setting contents on the liquid crystal display 112 and accepts changes of the screen setting information using the input/output device 104 (Step S224). The relationship information display device 100 also displays, though not shown, a button which registers the setting contents and ends or a button which returns the setting contents to a default value on the liquid crystal display 112. The user can change the contents of the following items via the input/output device 104.

(1) A rate of the area in gradation representation and contents of brightness display in the circle 122:

The user can set the rate of two areas: an area in the vicinity of the circumference of the circle 122 with the highest brightness, and an area close to the center with the lower brightness. The user can set arbitrary a boundary position between the area of the circle 122 with the highest brightness and the area in the gradation representation where the brightness is less than that by designating a radius vector of the boundary. Also, it is possible to set to the default value set in advance. Also, the user can select whether the brightness change in the circle 122 is step-by-step or continuous. In case the brightness is changed step by step, it is possible to select colors according to the level of the brightness among a plurality of colors prepared in advance. When the area in gradation representation where the brightness is low grows too much, visibility declines. On the other hand, when the area in gradation representation becomes too small, an expression in which the information is falling toward the center of the circle 122 becomes difficult to understand. In the example shown in FIGS. 7-9, the area in gradation representation is made about ⅓ of the circular area in terms of the radius vector.

(2) Positions where an icon for display which displays the information in the circle 122 is reduced and erased:

In case an icon at a position closer to the origin than a certain radius vector length is reduced and an icon other than that is not reduced, and displayed, the user can set the reduction starting position by designating the radius vector. As an example, the radius vector of ½ of the radius of the circle 122 is made the reduction starting position of the icon. In this case, when a radius vector of an icon which becomes a target for display is longer than ½ of the radius of the circle 122, reduced display of the icon will not be performed. Also, when a radius vector of an icon which becomes a target for display is shorter than ½ of the radius of the circle 122, the icon is displayed with a display scaling factor according to its length. Also, not setting the reduction starting position, the user can designate a specific curve illustrating reduction percentage when a size of an icon is reduced according to a radius vector. This will be described later. Also, the user can designate a distance rTH from the center of the circle 122 to the innermost circumference of the display area. In case an icon moves on the display screen toward the center of the circle 122, when a radius vector of the icon falls below rTH, the icon is not displayed any more and it looks as if it is erased. Further, display of the relationship information has reversibility by the operation of the up and down keys 111. For this reason, when a reduction starting position and an erase position is being set, and in case the up key is operated, the same position can be a position where expansion of a reduced icon is suspended or a position where an erased icon is displayed in the circle 122 again.

FIG. 12 shows an example of a characteristic curve representing relationship between a display scaling factor and a radius vector of an icon. In the characteristic curve shown here, when the radius of the circle 122 shown in FIGS. 7-9 is set to R, the display scaling factor of an icon (refer to FIGS. 7-9) is made 1 (same magnitude). And the closer the radius vector approaches the center of the circle 122, the larger a degree of reduction becomes, and at a point where it approaches the center to some extent the display scaling factor decreases rapidly. When the display scaling factor of an icon becomes small to some extent, identifying it becomes difficult. Also, there is a possibility that, because the icons of a plurality of the no-attention information overlap in a small area in the vicinity of the center, identification of the icons becomes difficult. Accordingly, when the radius vector falls below the predetermined numerical value rTH, the icon will not be displayed

Return to FIG. 11 and description is continued. The user corrects the setting contents displayed on the liquid crystal display 112 appropriately as needed, registers the setting contents and presses the button of setting completed (Step S225: Y). When the button of setting completed is pressed, the relationship information display device 100 overwrites by the contents with the screen display setting information after correction which is stored in a memory unit, not shown, of the concave expression section 106 (Step S226), and ends the processing for setting (end).

In contrast, in case the user presses a button which recovers the default value (Step S227: Y), the relationship information display device 100 reads the default value stored in the memory 102, overwrites it in the memory unit mentioned above of the concave expression section 106 (Step S228) and returns to Step S224.

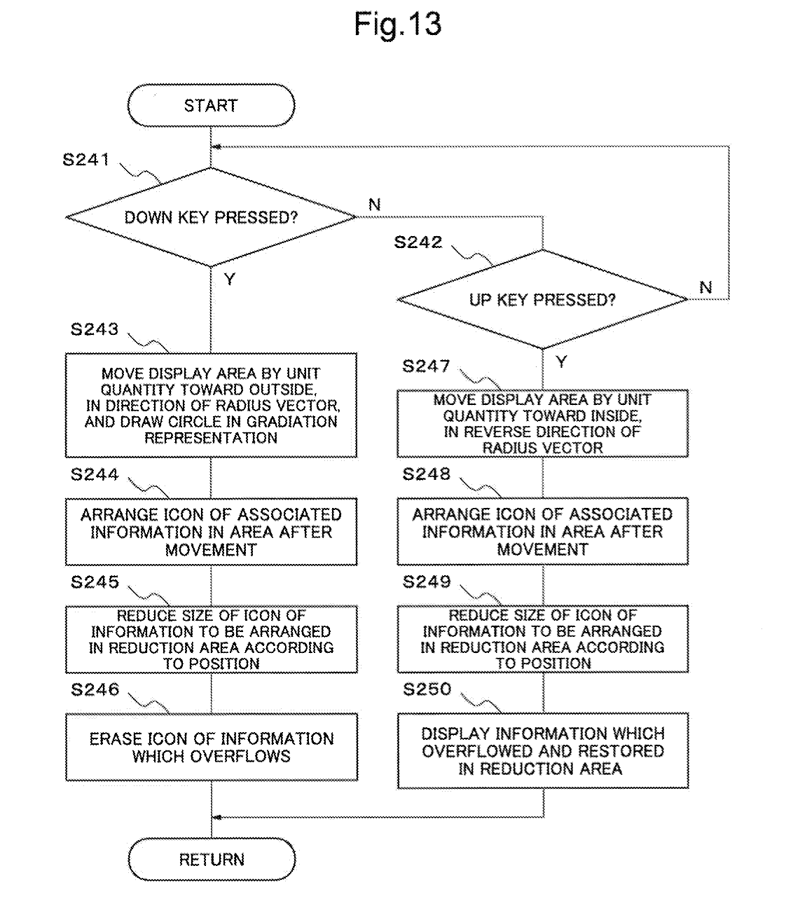

FIG. 13 illustrates the way of change in the display control by pressing of the key after the relationship strength of each information is displayed on the liquid crystal display initially. Description will be made with FIG. 4 and FIGS. 7-9.

On the liquid crystal display 112, the initial state is displayed as shown in FIG. 7. In this state, the display area moving section 107 of the relationship information display device 100 is monitoring pressing of the down key (Step S241) and pressing of the up key (Step S242) of the up and down keys 111. In case the user presses the down key of the up and down keys 111 (Step S241: Y), the display area moving section 107 moves the display area in the circle 122 displayed on the liquid crystal display 112 toward the direction of the radius vector by the unit quantity and draws the circle 122 in gradation representation (Step S243).

When the display area is moved, the display area moving section 107 arranges (moves) the icon of the no-attention information so that it may correspond to the area after movement (Step S244). For example, as a result of pressing of the down key of the up and down keys 111 being repeated for a predetermined amount, suppose the area has moved as shown in FIG. 8 at a certain time. The display position of the no-attention information D2 in the state of FIG. 8 has moved compared with the display position of the no-attention information D2 in FIG. 7 in the direction of the center of the circle 122. Accordingly, the icon 1312 of the no-attention information D2 is arranged (moved) at the position after the movement. Also, when there is one appearing newly in the circle 122 like the icon 1313 of the no-attention information D3, this will be arranged at the position.

The display area moving section 107 reduces and displays the icon of the no-attention information which is arranged in an area where the size of the icon is reduced (hereinafter, referred to as reduction area) according to the position (Step S245). In FIGS. 7-9, it is supposed that a white area in the circle 122 is not the reduction area, and an area with the color other than white is the reduction area. In FIG. 8, the display position of the no-attention information D2 is included in the reduction area. Accordingly, the display area moving section 107 displays the icon 1312 of the no-attention information D2 with the display scaling factor according to the position of the no-attention information D2. In what size the icon 1312 is displayed according to the position in the reduction area is based on the screen setting information described in FIG. 11.

Next, when an icon of no-attention information which goes off from the display area exists, the display area moving section 107 erases this from the display in the circle 122 (Step S246). For example, the no-attention information D2 displayed in FIG. 8 is erased in FIG. 9. At what time an icon of no-attention information such as the no-attention information D2 becomes not displayed is based on the screen setting information described in FIG. 11.

When processing of Steps S243-S246 mentioned above is performed for the pressing of the down key of the up and down keys 111 for the unit quantity, processing returns to Step S241 again (return). That is, while the user is repeating the pressing of the down key of the up and down keys 111, processing of Steps S243-S246 mentioned above is repeated, and display where an icon of information displayed on the display area of the liquid crystal display 112 moves in the direction toward the origin is performed. Because its size and resolution are limited, the liquid crystal display 112 may not be able to display all of the icons 1312, 1313 and 1314 of the no-attention information D2, D3 and D4 together. As mentioned above, the relationship information display device of this embodiment makes only a part of the area of the information space as the target for display and decides, by directions via the up and down keys 111 and in the information space, the display range where the information included inside is made the target for display. In case an area close to the center of the information space is the display range, an icon of no-attention information which exists in the vicinity of the center of the information space and included in the display range is displayed in the display area. Also, in case an area distant from the center of the information space becomes the display range by the directions via the up and down keys 111, an icon of no-attention information which exists at a location distant from the center of the information space and included in the display range is displayed in the display area.

On the other hand, in case the up key of the up and down keys 111 is pressed (Step S241: N, Step S242: Y), display processing completely opposite to Steps S243-S246 is performed (Steps S247-S250). First, when the user presses the up key of the up and down keys 111 (Step S242: Y), the display area moving section 107 moves the display area in the circle 122 on the liquid crystal display 112 by the unit quantity toward inside, in the reverse direction of the radius vector (Step S247).

When the display area is moved, the display area moving section 107 arranges (moves) the no-attention information so that it may correspond to the area after movement (Step S248). Next, for the information which is arranged in the area where a size of an icon is reduced (hereinafter, referred to as reduction area), the display area moving section 107 reduces and displays the icon according to the position (Step S249). Also, concerning an icon which moves from the reduction area to an area where the usual size is displayed, its size is returned to the usual size from the reduced size.

Next, when there exists, among the no-attention information which went off from the display area and is erased, one which will be displayed newly with reduced size, the display area moving section 107 restores it in the reduction area with the display scaling factor and display it (Step S250). For example, in case display changes from display contents of FIG. 9 to display contents of FIG. 8, the no-attention information D2 will be displayed in the reduction area newly. At what time no-attention information such as the no-attention information D2 is displayed is based on the screen setting information described in FIG. 11. After processing of Steps S247-S250 mentioned above is performed, processing returns to Step S241 again (return).

According to this embodiment described above, calculation method of the radius vector length and the central angle were not described concretely. Concerning the above, it is possible to use a physical model which sets attraction and repulsion between the information, for example, described in patent document 1.

Thus, according to the relationship information display device 100 of this embodiment, it is possible to display relationship of various information on a limited display area through a simple key operation of the up and down keys 111. Moreover, according to this embodiment, the operation of the up and down keys 111 and the movement of the display area on a screen work together and an expression is performed such that the information which overflows display falls toward the origin of the polar coordinate plane. Accordingly, the operational direction of the up and down keys 111 and the direction of the movement of the display area coincide visually, and the user can have a sense that the information itself is moving on the polar coordinate and needs not be conscious of the change in the display area. For this reason, the effect is obtained such that anyone can understand the operation of the relationship information display device 100 easily and a wrong operation becomes fewer.

<The First Modification Example of the Third Exemplary Embodiment>

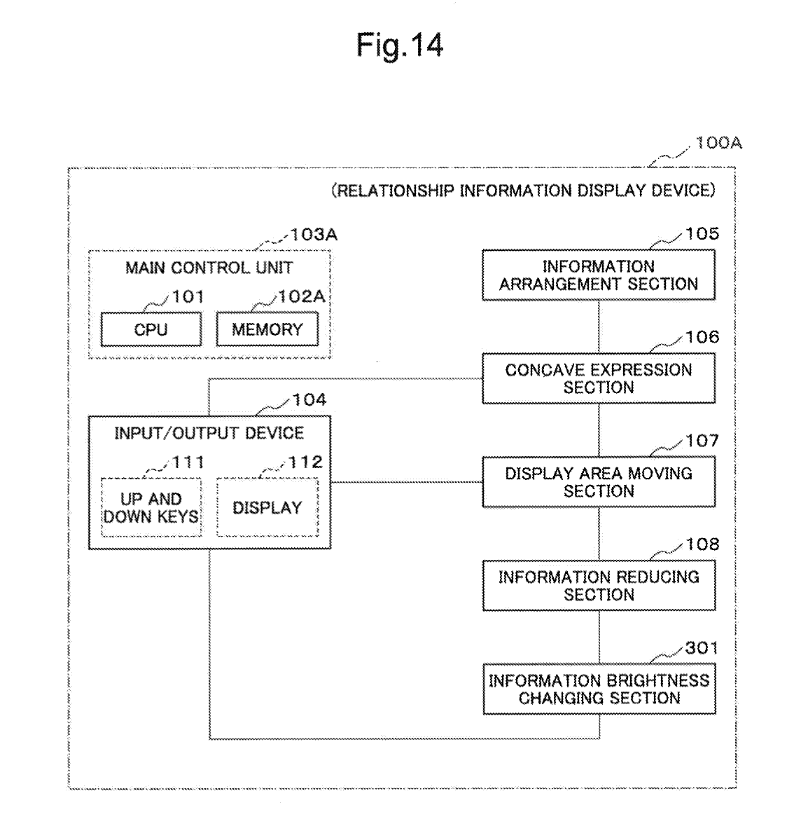

FIG. 14 illustrates a structure of a relationship information display device in the first modification example of the third exemplary embodiment. In this FIG. 14, identical parts as in FIG. 4 are attached the identical codes and their description will be omitted appropriately.

A relationship information display device 100A in this modification example transmits the information after processing of the information reducing section 108 to an information brightness changing section 301. The information brightness changing section 301 adjusts brightness of a background part of an icon of no-attention information arranged in the display area on the liquid crystal display 112 so that the more inside in the direction of the radius vector, the darker it becomes. A main control unit 103A stores in its memory 102A a control program which enables control including adjustment of the brightness of the background part of the icon in the display area. In this control program, the brightness of the icon which represents the no-attention information which is arranged at an inside boundary of the display area in the direction of the radius vector in the circle 122 shown in FIGS. 7-9 in the previous embodiment is made lowest. And in the direction of the radius vector toward outside, the brightness of the icon of the no-attention information displayed on the display screen is made brighter.

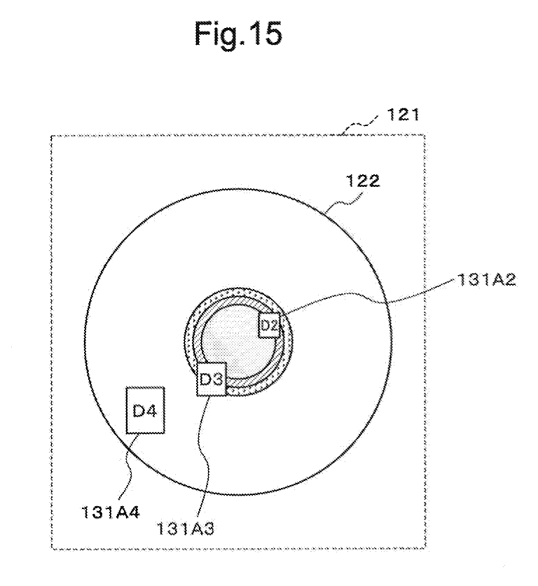

FIG. 15 illustrates an example of the state which displayed on the screen a partial area of the whole information space in this modification example. The no-attention information D2, D3 and D4 arc included in an area which is a target for display in FIG. 15. In FIG. 15, identical parts as in FIGS. 7-9 are attached the identical codes and their description will be omitted appropriately.

In FIG. 15, icons 131A2, 131A3 and 131A4 representing the no-attention information D2, D3 and D4 in the previous embodiment are arranged respectively at a corresponding spot in the circle 122 drawn on the display screen 121. In this example, the brightness of the color part in the circle 122 is changing in four levels from the center part to the peripheral part. The brightness of the background color of the icon 131A2 which is arranged relatively in the center part of the circle 122 and which represents the no-attention information D2 coincides with the color in the position of the radius vector where it is arranged. As a result, the brightness of the background color of the icon 131A2 is dark in the second place among the four levels of the brightness of the color. The brightness of the background color of the icon 131A3 representing the no-attention information D3 coincides with the color in the position of the radius vector where it is arranged. As a result, the brightness of the background color of the icon 131A3 is dark in the third place among the four levels of the brightness of the color. The brightness of the background color of the icon 131A4 which is arranged relatively in the peripheral part of the circle 122 and which represents the no-attention information D4 coincides with the color in the position of the radius vector where it is arranged. As a result, the brightness of the background color of the icon 131A4 is the lightest among the four levels of the brightness of the color.

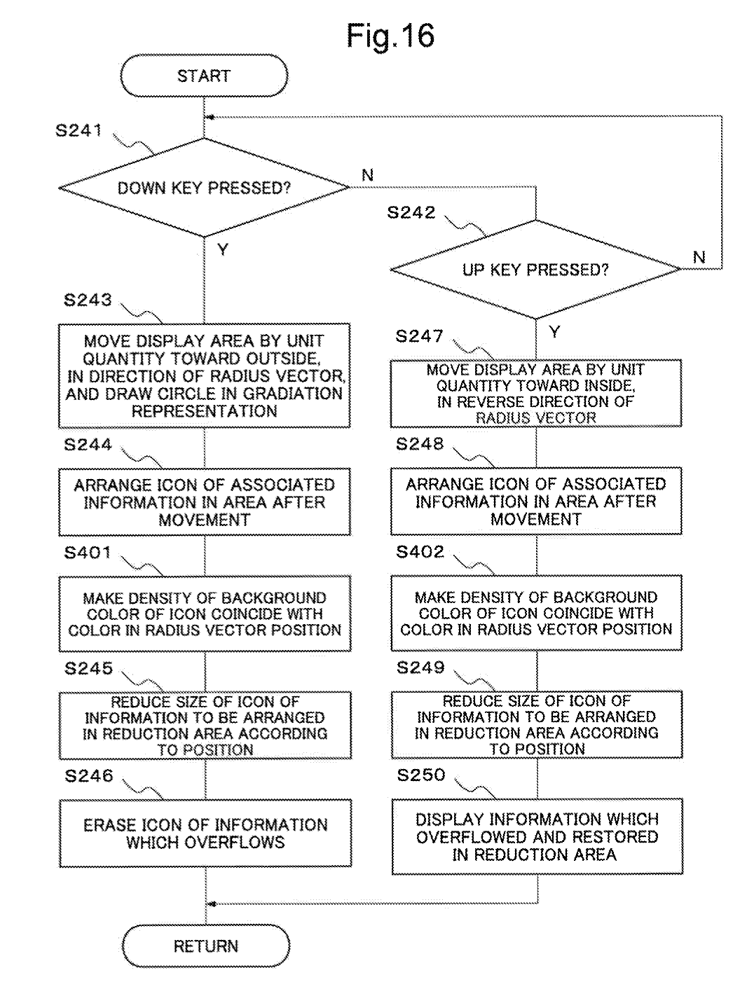

FIG. 16 illustrates the way of control of the background color of an icon in this modification example. In this FIG. 16, identical parts as in FIG. 13 are attached the identical codes and their description will be omitted appropriately. Description will be made with FIG. 14 and FIG. 15.

On the liquid crystal display 112, icons are arranged same as shown in FIG. 7 in the initial stats. However, the background of the icon is made to coincide with the color in the position of the radius vector of the no-attention information in the circle 122.

When the down key of the up and down keys III. is pressed (Step S241: Y), and the display area is moved (Step S243), the display area moving section 107 arranges (moves) the icon 131A of the no-attention information so that it may correspond to the area after movement (Step S244). Next, the brightness of the background color of each of the icons arranged in the circle 122 is made to coincide with the color of the display area in the position of the radius vector where the no-attention information is arranged (Step S401). After that, proceed to processing of Step S245.

On the other hand, when the up key of the up and down keys 111 is pressed (Step S241: N, Step S242: Y), and the display area is moved (Step S247), the display area moving section 107 arranges (moves) the icon of the no-attention information so that it may correspond to the area after movement (Step S248). Next, the brightness of the background color of each of the icons arranged in the circle 122 is made to coincide with the color of the display area in the position of the radius vector where the no-attention information is arranged (Step S402). After that, proceed to processing of Step S249.

As has been described above, in this modification example, the brightness of the background part of each icon becomes darker according to the position of the radius vector of the no-attention information as it approaches the center of the circle 122. Accordingly, by paying attention to the brightness and the sire of each icon, the user can grasp the change in the radius vector of the no-attention information corresponding to these icons easily. Also, when the display range of the display area changes in the polar coordinate plane, expression in which the information which overflows the display area toward inside, in the reverse direction of the radius vector, is falling toward the back of the screen can be realized with more emphasis than the previous embodiment. As a result, the operational direction of the up and down keys 111 and the direction of the movement of the arrangement information accompanying the change in the display area agree better visually.

<The Second Modification Example of the Third Exemplary Embodiment>

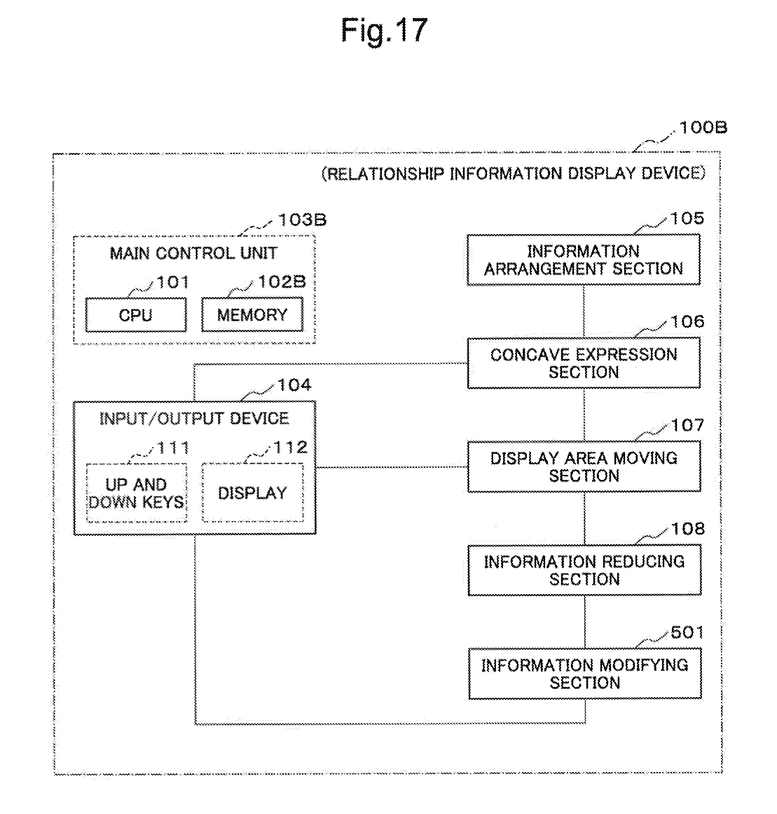

FIG. 17 illustrates a structure of a relationship information display device in the second modification example of the third exemplary embodiment. Hereinafter, description will be made centering on a point of difference with the third exemplary embodiment whose structure is shown in FIG. 4. In the structure of this modification example shown in FIG. 17, identical elements with the third exemplary embodiment shown in FIG. 4 is attached the identical code with FIG. 4 and its description is omitted.

A relationship information display device 100B in this modification example transmits the information after processing of the information reducing section 108 to an information modifying section 501. The information modifying section 501 makes two sides among four sides which constitute the outline of the icon of the no-attention information segments which are parallel to a tangent line of the circle 122 at a point of intersection between a straight line which connects the origin and the point where the no-attention information is arranged and the circle 122, and in the center of each of which, the straight line goes through. And the information modifying section 501 makes the length of these two parallel sides to the length which is the length of the radius vector at the central position of each of the sides multiplied by a predetermined constant number. Also, the distance between the two parallel sides is made, for example, the length of the segment which connects the origin and the central point of the side closer to the origin out of the two parallel sides multiplied by a predetermined constant number. The shape of the icon is a trapezoid including the parallel two sides mentioned above and other two sides of which the length is equal each other. A main control unit 103B stores in its memory 102B a control program which enables additionally the control mentioned above.

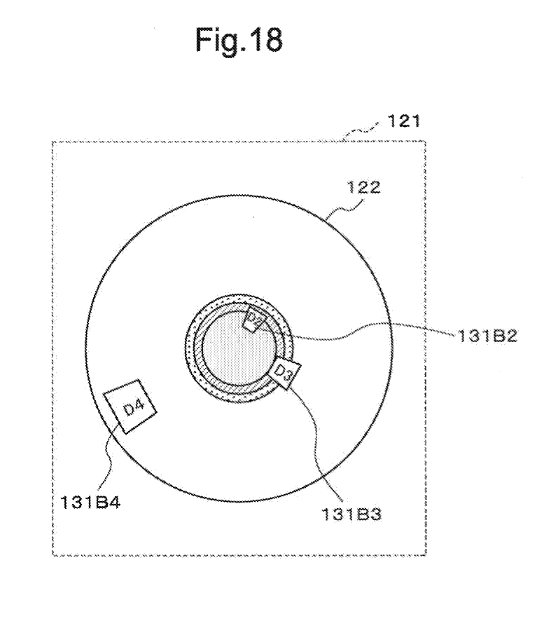

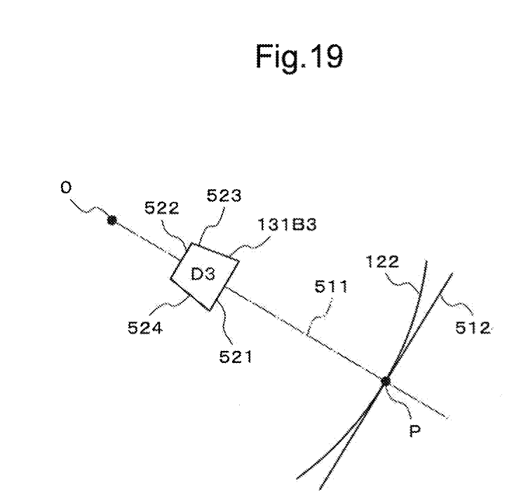

FIG. 18 shows an example of display of the icons of three of the no-attention information D2, D3 and D4, and FIG. 19 shows the way of modification of the icon concerning one of them. FIG. 19 shows, focusing on the no-attention information D3, the way of modification of its icon 131B3. The icon 131B3 includes two sides 521 and 522 which are parallel to a tangent line 512 at a point P where a straight line 511 which extends a segment which connects the origin O of the circle 122 and the point where the no-attention information D3 is arranged (not shown) crosses with this circle 122. Each of the lengths of these two sides 521 and 522 is the length which is the length of the radius vector at the position where these sides cross the straight line 511 multiplied by a predetermined constant number. Other two sides 523 and 524 of the trapezoid which constitutes the icon 131B3 are with the equal length each other, connect with two sides 521 and 522 and constitute the trapezoid.

The information modifying section 501 shown in FIG. 17 draws icon 131B2 and 131B4 of two of the other no-attention information D2 and D4 shown in FIG. 18 also by a similar method. Accordingly, four sides of the trapezoid which constitute the icon 131B4 will be longer than the length of the corresponding sides of the four sides which constitute the icon 131B3 respectively. Also, four sides of the trapezoid which constitute the icon 131B2 will be shorter than the length of the corresponding sides of the four sides which constitute the icon 131B3 respectively.

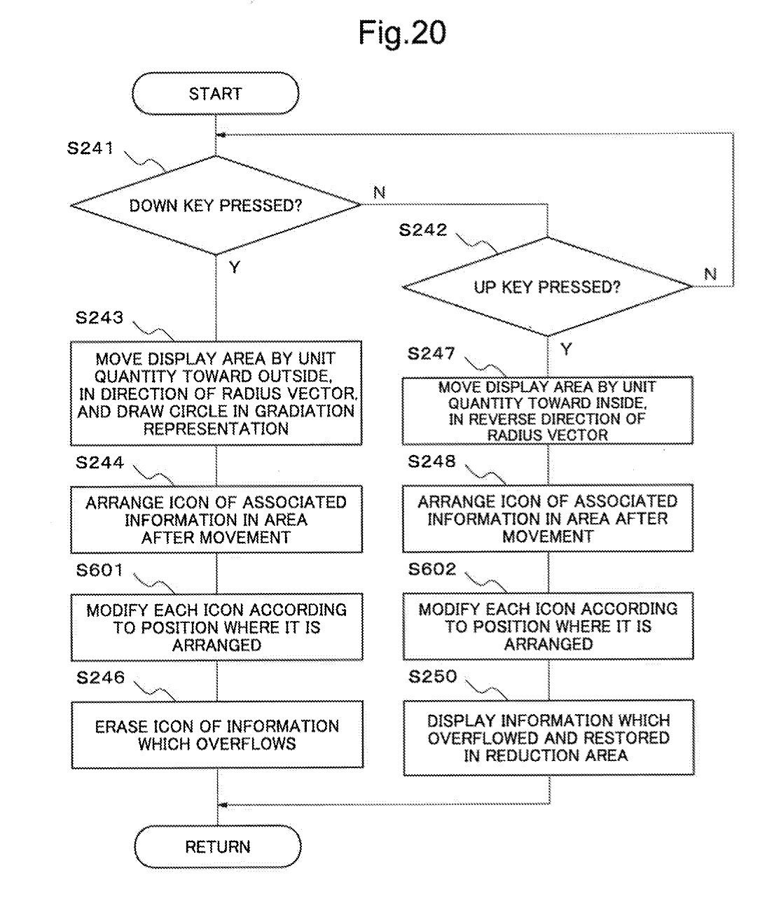

FIG. 20 is a flow chart illustrating display processing of an icon in the second modification example. Here, description will be made centering on a point of difference with the display processing of the third exemplary embodiment shown in FIG. 13. Referring to FIG. 13 and FIG. 20, the point that Step S245 and Step S249 in FIG. 13 become Step S601 and Step S602 in FIG. 20 respectively is the difference, and the other steps are identical. The detailed description of the step which is attached the identical code with FIG. 13 will be omitted. Description will be made with FIG. 17 and FIG. 18. Also, FIG. 7 is referred as needed, and in this case, read the icons 1312-1314 for the icons 131B2-131B4 respectively.

On the liquid crystal display 112, icons are arranged same as shown in FIG. 7 in the initial state. When the down key of the up and down keys 111 is pressed (Step S241: Y), and the display area is moved (Step S243), the display area moving section 107 arranges (moves) the icon of the no-attention information so that it may correspond to the area after movement (Step S244). Next, modify the four sides of the trapezoid which constitute the outline of each of the icons arranged in the circle 122 according to the positions where they are arranged. Concretely, the information modifying section 501 performs the operation described in FIG. 19, and draws each of the icons (Step S601). After that, proceed to processing of Step S246.

On the other hand, when the up key of the up and down keys III is pressed (Step S241: N, Step S242: Y), and the display area is moved (Step S247), the display area moving section 107 arranges (moves) the icon of the no-attention information (Step S248) so that it may correspond to the area after movement. Next, modify the four sides of the trapezoid which constitute the outline of each of the icons arranged in the circle 122 according to the positions where they are arranged. Concretely, the information modifying section 501 performs the processing described in FIG. 19, and draws each of the icons (Step S602). After that, proceed to processing of Step S250.

As has been described above, in this modification example, each of the icons 131B2, 131B3 and 131B4 are expressed with the length proportional to the radius vector of the no-attention information D2, D3 and D4. For this reason, each of the icons 131B2, 131B3 and 131B4 are drawn with the size according to the positions in the circle 122 respectively. As a result, in case the number of the no-attention information displayed together in the circle 122 is relatively large, they may be arranged well-balanced and can be expressed easy to sec. Moreover, when moving the display area in the polar coordinate plane, expression in which the information which overflows the display area toward inside, in the reverse direction of the radius vector, is falling toward the back of the screen can be realized with more emphasis that the embodiment. Also, the operational direction of the up and down keys 111 and the direction of the movement of the display area in the circle 122 agree visually.

<The Third Modification Example of the Third Exemplary Embodiment>

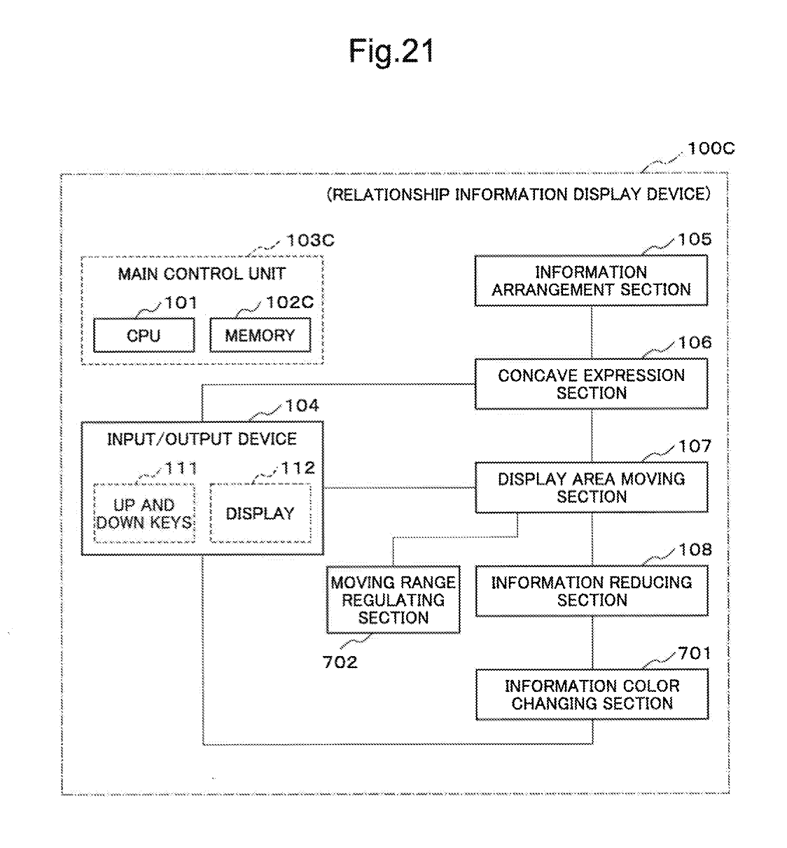

FIG. 21 is a figure illustrating a structure of a relationship information display device in the third modification example of the third exemplary embodiment. Hereinafter, description will be made centering on a point of difference between this modification example shown in FIG. 21 and the third example shown in FIG. 4. Because the elements which are attached the identical code in FIG. 21 and FIG. 4 are identical, their detailed description will be omitted.

A relationship information display device 100C of this modification example includes an information publication description changing section 701 and a moving range regulating section 702 in addition to the structure of the relationship information display device 100 shown in FIG. 4.

The relationship information display device 100C in this modification example transmits the information after processing of the information reducing section 108 to the information color changing section 701. The information color changing section 701 decides the color of the icon of the no-attention information-arranged in the display area according to the degree of the relationship strength between the corresponding no-attention information and the attention information. For example, the color of the icon of the no-attention information of which the relationship strength with the attention information is largest is made red which is the color of the light with long wavelength among visible light. On the other hand, the color of the icon of the no-attention information of which the relationship strength with the attention information is smallest is made blue which is the color of the light with short wavelength among visible light. The color of the icon of the other no-attention information is made the color of the light of the wavelength longer than the wavelength of blue light and shorter than the wavelength of red light. The wavelength of the light of the color which is assigned to each of the icons may be made, for example, the wavelength of which the difference between the wavelength and the wavelength of blue light is proportional to the difference between the relationship strength of the no-attention information corresponding to the icon with the attention information and the minimum value of the relationship strength. Assignment of the color may be reverse. The moving range regulating section 702 restricts the range of the display area displayed on the liquid crystal display 112 by the pressing of the up and down keys 111 to the range where a series of the no-attention information is displayed. A main control unit 103C stores in its memory 102C a control program which enables additionally the control mentioned above.

In order to prevent the icon of all the no-attention information which becomes the target for display from moving from the display area toward inside, in the reverse direction of the radius vector, and from moving toward outside of the display area in the direction of the radius vector, the moving range regulating section 702 checks the position where icons are displayed.

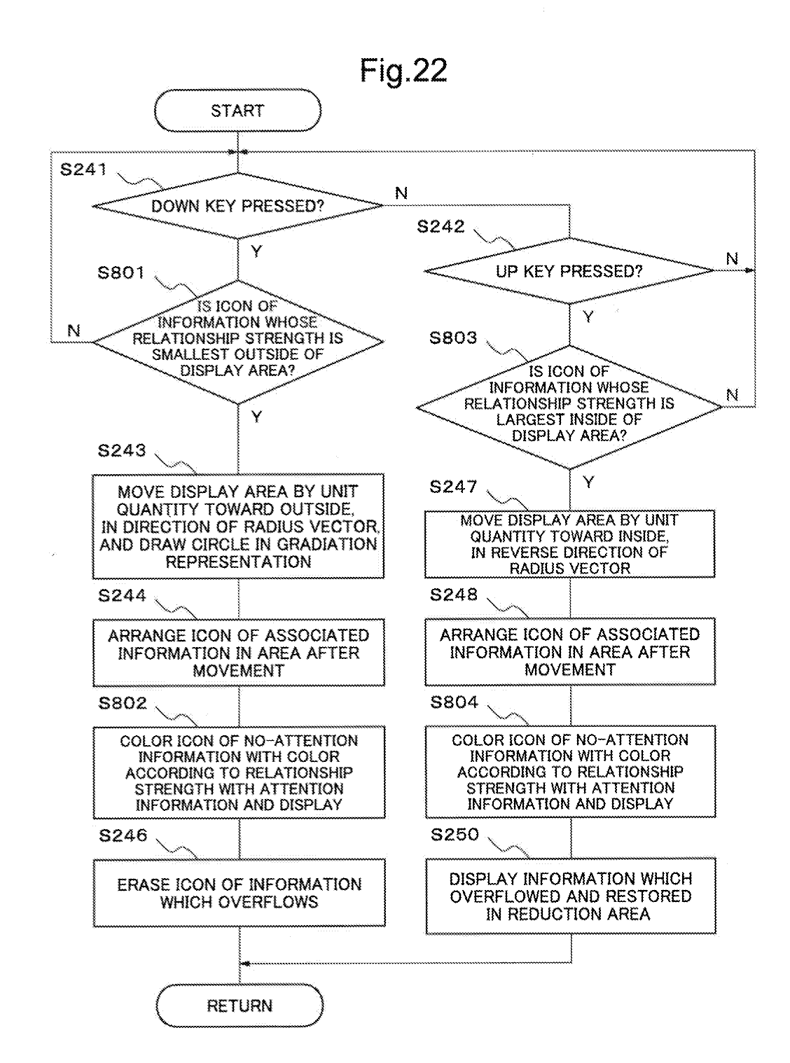

FIG. 22 is a flow chart illustrating display processing of an icon in this modification example. Hereinafter, description will be made centering on a point of difference between a flow chart showing the operation of the third exemplary embodiment shown in FIG. 13 and a flow chart showing the operation of this modification example shown in FIG. 22. Because the steps which are attached the identical code in FIG. 13 and FIG. 22 are identical, their detailed description will be omitted. Description will be made with FIG. 21. Also, FIGS. 7-9 will be referred as needed, and in this case, read the icons 1312-1314 for the icons 131C2-131C4 respectively.

In the initial state, it is supposed that the arrangement of an icon displayed on the liquid crystal display 112 is, for example, similar to the arrangement of the icon shown in FIG. 7. Suppose the down key of the up and down keys 1 111 is pressed in this state (Step S241: Y). Then, the moving range regulating section 702 connected to the display area moving section 107 checks, among the no-attention information which becomes a target for display, whether a display position of an icon of the no-attention information of which the relationship strength with the attention information is smallest is outside of the display area (Step S801). In FIGS. 7-9, the display area is the range surrounded by the circle 122 and the innermost circle. In case a display position of an icon is in the display area, the icon is displayed. Accordingly, in Step S801, it is enough to distinguish whether an icon of the no-attention information of which the relationship strength with the attention information is smallest exists inside of the circle 122.

It is supposed that, similar to the exemplary embodiment mentioned above, the attention information D1 and the no-attention information D2, D3 and D4 have the relationship strength shown in FIG. 6. In this modification example, icons representing the no-attention information D2, D3 and D4 are supposed to be the icons 131C2, 131C3 and 131C4 respectively. Among the no-attention information D2, D3 and D4, whose relationship strength between the attention information is smallest is the no-attention information D4. In this case, the moving range regulating section 702 checks whether the icon 131C4 exists within the circle 122.

When the icon corresponding to the no-attention information of which the relationship strength between the attention information is smallest exists in the circle 122, there is no other no-attention information of which the display position is a location farther from the origin than the circumference of the circle 122. Accordingly, even if the display range is moved toward outside, in the direction of the radius vector, an icon of other no-attention information will not appear in the display area any more. Accordingly, when the display position of the icon which corresponds to the no-attention information of which the relationship strength between the attention information is smallest is distinguished not to be outside of the display area (inside of the circle 122) (Step S801: N), processing returns to Step S241. In this case, movement of the display area by the pressing of the down key performed just before is not performed. Further, depending on the relationship information display device 100C, error sound may be outputted at this time, and may draw the user's attention.

In contrast, in case the display position of the icon corresponding to the no-attention information of which the relationship strength between the attention information is smallest is distinguished to be outside of the display area (outside of the . circle 122) (Step S801: Y), the display area is moved toward the direction of the radius vector (Step S243, Step S244). And the information publication description changing section 701 colors the icons of all the no-attention information displayed in the display area with the color according to the relationship strength with the attention information (Step S802). At this time, the brightness of each of the icon may further be changed according to the radius vector of the display position of the icon. Also, it is possible to modify the shape profile of the icon of the no-attention information which becomes a target for display similar to the second modification example. After that, proceed to processing of Step S246.

Next, the case when the up key of the up and down keys 111 is pressed (Step S241: N, Step S242: Y) will be described. In this-case, the moving range regulating section 702 checks, among the no-attention information which becomes a target for display, whether a display position of an icon of the no-attention information of which the relationship strength with the attention information is largest exists inside of the display area in the reverse direction of the radius vector and is in the state not to be displayed in the display area (Step S803). In an example of FIGS. 7-9, the display area is an area surrounded by the circle 122 and the innermost circle. Accordingly, in this case, it is enough to judge whether a position in the information space of the no-attention information of which the relationship strength is largest exists inside of the innermost display range toward the origin. Or, a radius vector of the icon of the no-attention information of which the relationship strength is largest may be judged whether it is inside of the innermost circle.

Among the no-attention information D2, D3 and D4, it is the no-attention information D2 of which the relationship strength between the attention information is largest. Accordingly, in this example, the moving range regulating section 702 judges whether a position in the information space of the no-attention information D2 is inside of the display range in the reverse direction of the radius vector. Or, the moving range regulating section 702 checks whether the display position of the icon 131C2 of the no-attention information D2 is inside of the display area in the reverse direction of the radius vector and in the state that the icon 131C2 is not displayed.

In the information space, there exists no other no-attention information at a position closer to the center than the no-attention information of which the relationship strength is largest. Accordingly, in case the position of the no-attention information of which the relationship strength between the attention information is largest is not inside of the display range in the direction of the radius vector, even if the display area is moved toward inside, in the reverse direction of the radius vector, an icon of other no-attention information which appears in the display area newly does not exist. That is, even if the up key is pressed further, there is no possibility that other icons may appear in the display area.

Accordingly, in case the display position of the icon of the no-attention information of which the relationship strength with the attention information is largest is not inside of the display area (Step S803: N), processing returns to Step S241, and movement of the display area by the pressing of the up key is not performed. Depending on the relationship information display device 100C, error sound may be outputted at this time, and may draw the user's attention.

In contrast, in case the display position of the icon of the no-attention information of which the relationship strength with the attention information is largest is inside of the display area and the icon is not displayed in the display area, by moving the display area toward inside, in the reverse direction of the radius vector, following the operation of the up key, there is a possibility that at least the icon of the no-attention information of which the relationship strength with the attention information is largest may appear on the display area. Accordingly, in case the display position of the icon of the no-attention information of which the relationship strength with the attention information is largest is inside of the display area (Step S803: Y), the display area moving section 107 moves display area in the reverse direction of the radius vector (Step S247, Step S248). And the information color changing section 701 changes the color of the icon of all the no-attention information displayed in the display area to the color according to the relationship strength with the attention information (Step S804). At that time, the information color changing section 701 may change the brightness of each of the icons according to the radius vector of the icon. Also, it is possible to modify the outline of the icon of each of the no-attention information similar to the second modification example. After that, proceed to processing of Step S250.

As has been described above, in this modification example, because the relationship information display device 100C includes the information color changing section 701, the user can grasp intuitively to which of all the area of the information space shown in FIG. 5 the no-attention information displayed in the display area belongs. Also, because the relationship information display device 100C includes the moving range regulating section 702, situations where the up and down keys 111 is pressed toward one direction excessively and all of the no-attention information which should be displayed in the circle 122 will be outside of the display range can be avoided.

<The Fourth Modification Example of the Third Exemplary Embodiment>

In the previous embodiment and modification examples from the first to the third, although a case where the display area of the relationship information on the display screen is a circle has been described, it is not limited to this. The fourth modification example and the fifth modification example of the third exemplary embodiment are examples where the display area is other than a circle.

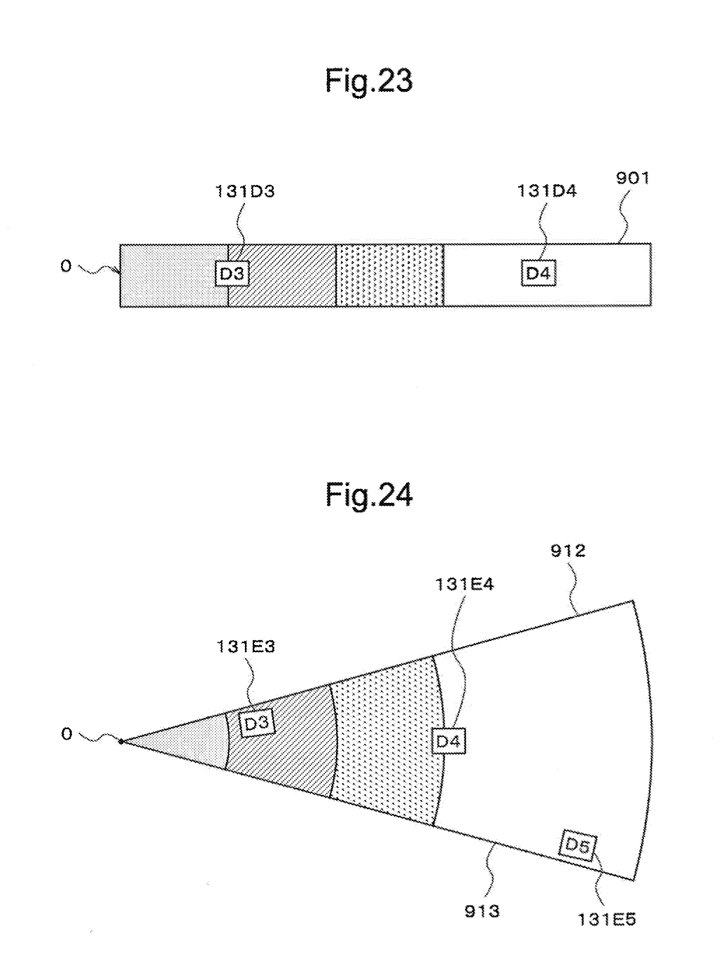

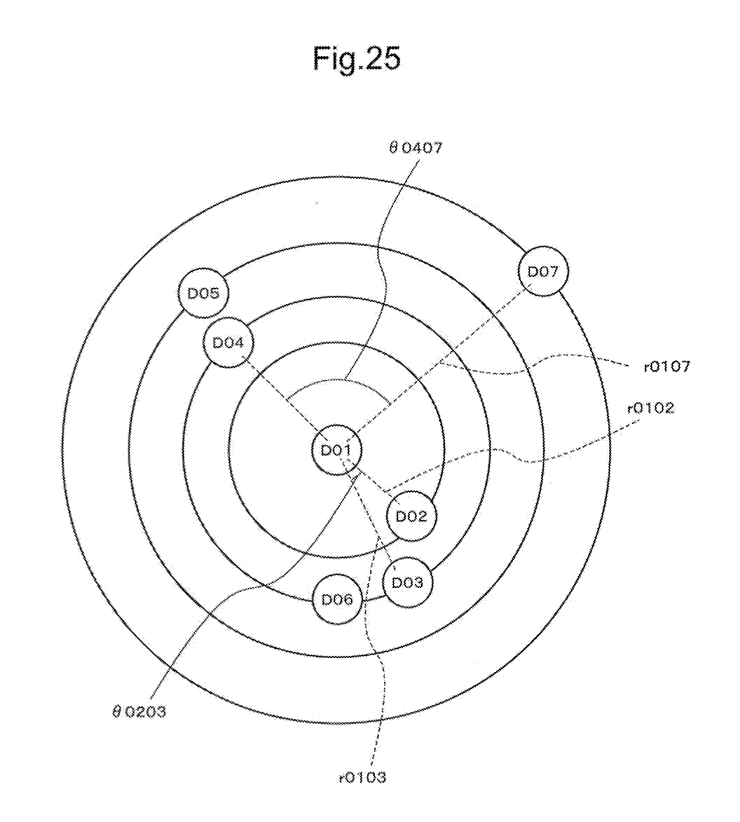

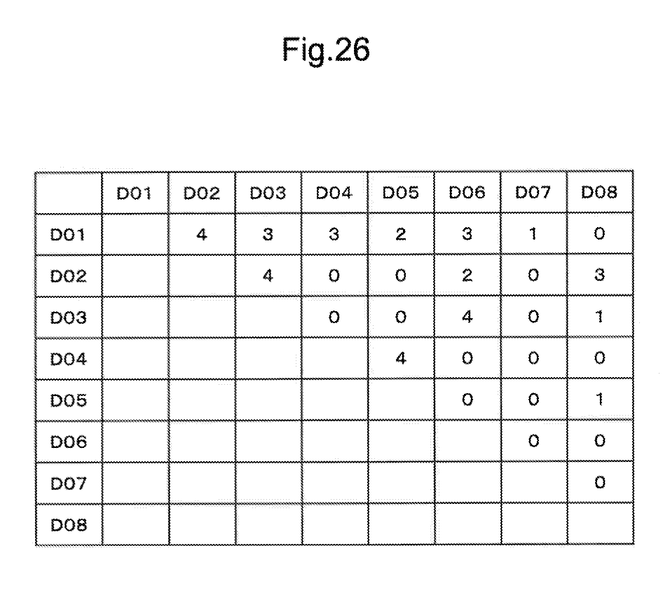

FIG. 23 is a figure illustrating a display area of a relationship information display device in the fourth modification example of the third exemplary embodiment. In this modification example, a display area 901 is an elongated rectangle.

Referring to FIG. 32, the left end of the display area 901 is the origin O. It is supposed that the attention information D1(not shown) is arranged at the origin. An icon of the no-attention information is displayed at the position in the display area 901 according to the relationship strength of each of the no-attention information with the attention information. Horizontal distance between the origin on the left end of the display area 901 and the displayed icon represents a degree of the relationship strength between the no-attention information corresponding to the icon and the attention information. The farther the position of an icon displayed in the display area 901 goes away from the origin on the left end, the smaller the relationship strength of the corresponding no-attention information with the attention information becomes. That is, the radius vector of FIG. 12 corresponds to the distance in the horizontal direction from the origin O of the display area 901. The display area 901 is divided into a plurality of areas. The brightness of each of the areas becomes higher as it leaves from the origin. Also, in the example of FIG. 32, an icon whose display position is the area on the left end closest to the origin among a plurality of the areas is not displayed.

In the example of FIG. 32, icons of the no-attention information D3 and D4 are displayed as 131D3 and 131D4.

In this modification example, an icon representing the relationship strength between each of the no-attention information and the attention information is moved on the display area by left and right keys. The relationship information display device of this modification example does not display an icon whose display position is on the right side of the right end of the display area 901 and an icon whose display position is on the left side of the right end of the area on the left end of the display area 901. Accordingly, an icon whose display position moved from the right end of the display area 901 further to the right side and an icon whose display position moved to the area on the left end of the display area 901 by the operation of the left and right keys disappear from the display area 901.

However, in this modification example, the relationship strength between each of the no-attention information cannot be displayed.

<The Fifth Modification Example of the Third Exemplary Embodiment>

FIG. 24 is a figure illustrating an example of a display area of a relationship information display device in the fifth modification example of the third exemplary embodiment.

A display area 911 of this modification example is a sector with a central angle smaller than 360 degrees with the origin O as a center. Although a display which is not shown may be in the shape of such a sector, such a sector may be displayed, for example, on a rectangular display. The relationship information display device of this modification example displays, in the display area 911, and at a position according to the relationship strength between each of the no-attention information and the attention information, an icon of the no-attention information.

Also, in this modification example, the origin O corresponds to the position of the attention information (not shown). Also, distance of the displayed icon from the origin represents a degree of the relationship strength between the attention information and each of the no-attention information corresponding to the icon. Further, an icon 131E2) of the no-attention information of which the display position approaches the origin O to some extent will not be displayed. Referring to FIG. 24, the display area 911 of sector is divided by an arc into a plurality of areas. In case inside of an area of a sector closest to the center among them is a display position of an icon, the icon is supposed not to be displayed.

The relationship information display device of this modification example represents the relationship strength between one of the no-attention information and the other no-attention information by a central angle of display positions of the no-attention information which serves as a reference and the other no-attention information. For example, suppose the no-attention information selected as the no-attention information which serves as a reference of the relationship strength among the no-attention information from the no-attention information having relationship with the attention information is the no-attention information Da. The display position of the selected no-attention information Da is made on one radius among two radii which constitute the sector, and at a position with radius vector length according to the relationship strength between the attention information and the no-attention information Da. Also, the display position of the no-attention information (suppose Db) of which the relationship strength with the no-attention information Da is smallest is made on the radius among two radii which constitute the sector on which the icon of Da is not arranged, and at a position with radius vector length according to the relationship strength between the attention information and the no-attention information Db. Central angle of a display position of other no-attention information will be decided according to a degree of the relationship strength between the no-attention information Da and so that it will be between the two radii which constitute the sector. Also, a radius vector of a display position of each of the no-attention information will be decided according to the relationship strength between the no-attention information and the attention information. Further, the display positions of the no-attention information Da and the no-attention information Db may not need to be on the radii which constitute the sector necessarily, and as far as they are inside the sector, they may be in the vicinity of the radii. Further, the no-attention information which serves as a reference may not be the no-attention information of which the relationship strength with the attention information is largest. Also, the no-attention information which serves as a reference may be selected not manually, but by a predetermined standard, for example, the relationship strength between the attention information.

In the example of FIG. 24, a central angle of a display position of each icon represents, with the no-attention information D3 corresponding to the icon 131E3 which is arranged on one side of the radius 912 which constitute the sector as a reference, a degree of the relationship strength between the no-attention information D3 and the no-attention information corresponding to the other icon. In the example of FIG. 24, the no-attention information of which the relationship strength between the no-attention information D3 is smallest is no-attention information D5. Icon 131E5 of the no-attention information D5 is arranged in the vicinity of the other radius 913 which constitutes the sector.

As far as it is no-attention information having relationship with the attention information, arbitrary no-attention information can be selected as a reference for comparison of the relationship strength among the no-attention information. Accordingly, the relationship information display device of this modification example can, as far as it is the no-attention information having relationship with the attention information, display the relationship strength of other no-attention information with the arbitrary no-attention information. Icons corresponding to each of the no-attention information are displayed, according to the no-attention information selected as a reference, at different positions.

This modification example has the effect that for a sector or an elongated rectangular area, not only the relationship between the attention information and each of the no-attention information but also the relationship among each of the no-attention information can be displayed.

<Other Exemplary Embodiments>

In the present invention, a relationship information display device includes: (a) a display window setting means which arranges at a fixed point in an area an origin representing attention information as one of information which should be paid attention, and as distance with the origin becomes, shorter, based on a characteristic curve between distance and a display scaling factor set in advance, sets a display window in which the display scaling factor approaches zero acceleratingly; (b) an extracted information displaying means which when, from relationship strength information which represents strength of relationship among a plurality of information set in advance, one of the information is made the attention information mentioned above and the remaining information is made no-attention information, extracts all the no-attention information mentioned above having the relationship beyond the strength which is designated to the attention information mentioned above, inputs it into the display window mentioned above set by the display window setting means mentioned above so that the designated strength mentioned above will be arranged at a farthest position from the origin of the display window mentioned above, and displays by attaching an identification mark representing their information at each of coordinate positions of the inputted no-attention information mentioned above; (c) a designated value increasing or decreasing means which increases or decreases a designated value of distance relationship; and (d) a display erasing means which erases display of the identification mark mentioned above of the no-attention information mentioned above which is positioned at a coordinate position closer to the origin than a specific coordinate position in the display window mentioned above.

Also, in the present invention, a relationship information display method includes: (a) an attention information setting step which arranges at a fixed single point in an area set in advance an origin representing attention information as one of information which should be paid attention, and based on a characteristic curve between distance and a display scaling factor set in advance, for a display window in which the display scaling factor approaches zero acceleratingly as the distance with the origin mentioned above becomes shorter, sets one information as the attention information mentioned above from a plurality of information set in advance which becomes a target to display strength of mutual relationship; (b) an increasing or decreasing step which, between the attention information mentioned above which is set by the attention information setting step, designates increase or decrease of a boundary value of a numerical value of the relationship strength which becomes a target for display in the display window mentioned above; (c) an identification mark assigning step which, from no-attention information as remaining information which is among a plurality of the information set in advance and mentioned above except the attention information mentioned above, extracts all the information which has the relationship more than the relationship strength designated by the increasing or decreasing step, determines a coordinate position of each of the no-attention information mentioned above so that the weaker the relationship strength with the attention information mentioned above is, the farther position from the origin of the display window mentioned above the no-attention information is arranged at, and assigns an identification mark to the no-attention information respectively for display: and (d) a display control step which, among the identification marks of the no-attention information which are assigned by the identification mark assigning step, erases display of those arranged at a coordinate position closer to the origin than the specific coordinate position in the display window mentioned above, and in addition, for the no-attention information with the coordinate position other than that, displays the identification mark at each position.

Moreover, the present invention is characterized by making a computer execute, as a relationship information display program: (a) attention information setting processing which arranges at a fixed single point in an area set in advance an origin representing attention information as one of information which should be paid attention, and based on a characteristic curve between distance and a display scaling factor set in advance, for a display window in which the display scaling factor approaches zero acceleratingly as the distance with the origin mentioned above becomes shorter, sets one information as the attention information mentioned above from a plurality of information set in advance which becomes a target to display strength of mutual relationship; (b) increasing or decreasing processing which, between the attention information mentioned above which is set by the attention information setting step, designates increase or decrease of a boundary value of a numerical value of the relationship strength which becomes a target for display in the display window mentioned above; (c) identification mark assigning processing which, from no-attention information as remaining information which is among a plurality of the information set in advance and mentioned above except the attention information mentioned above, extracts all the information which has the relationship more than the relationship strength designated by the increasing or decreasing step, determines a coordinate position of each of the no-attention information mentioned above so that the weaker the relationship strength with the attention information mentioned above is, the farther position from the origin of the display window mentioned above the no-attention information is arranged at, and assigns an identification mark to the no-attention information respectively for display; and (d) display control processing which, among the identification marks of the no-attention information which are assigned by the identification mark assigning step, erases display of those arranged at a coordinate position closer to the origin than the specific coordinate position in the display window mentioned above, and in addition, for the no-attention information with the coordinate position other than that, displays the identification mark at each position.

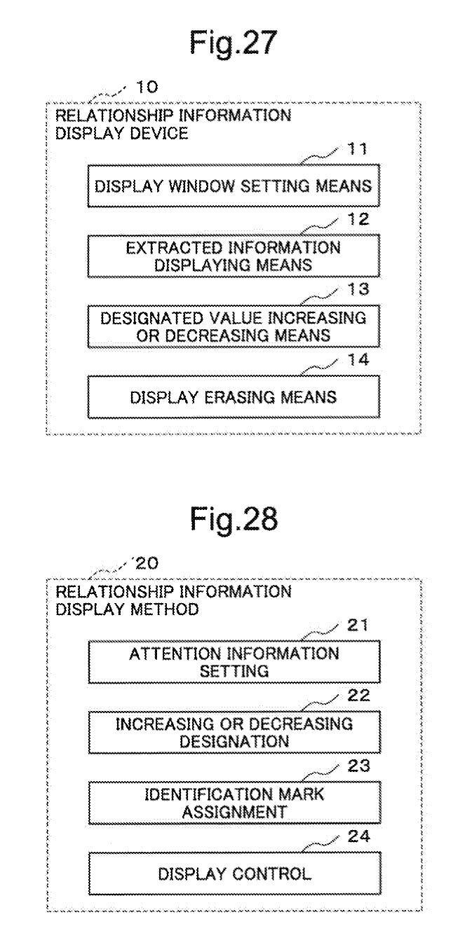

FIG. 27 shows a block diagram of a relationship information display device of other example of the present invention. A relationship information display device 10 of the present invention includes a display window setting means 11, an extracted information displaying means 12, a designated value increasing or decreasing means 13 and a display erasing means 14. Here, the display window setting means 11 arranges at a fixed point in an area an origin representing attention information as one of information which should be paid attention. And sets a display window which, as distance with the origin becomes shorter, based on a characteristic curve between distance and a display scaling factor set in advance, sets a display window in which the display scaling factor approaches zero acceleratingly. The extracted information displaying means 12 designates one of information from relationship strength information which represents strength of relationship among a plurality of information set in advance as the attention information mentioned above. And when all of the remaining information is made no-attention information, extracts all the no-attention information mentioned above having relationship beyond than the strength which is designated to the attention information mentioned above. After that, inputs it into the display window mentioned above set by the display window setting means 11 mentioned above so that the designated strength will be arranged at a farthest position from the origin of the display window mentioned above. And displays by attaching an identification mark representing their information at each of coordinate positions of the inputted no-attention information mentioned above. The designated value increasing or decreasing means 13 increases or decreases a designated value of distance relationship. The display erasing means 14 erases display of the identification mark mentioned above of the no-attention information mentioned above which is positioned at a coordinate position closer to the origin than a specific coordinate position in the display window mentioned above.

FIG. 28 shows a block diagram of a relationship information display method of other example of the present invention. A relationship information display method 20 of the present invention includes attention information setting 21, increasing or decreasing amount designation 22, identification mark assignment 23 and display control 24. Here, attention information setting 21 sets, for a display window, one of information as attention information from a plurality of information which becomes a target to display strength of mutual relationship as relationship strength and set in advance. This display window arranges at a fixed single point in an area set in advance an origin representing the attention information as one of information which should be paid attention. And, based on a characteristic curve between distance and a display scaling factor set in advance, display is performed such that the display scaling factor approaches zero acceleratingly as the distance with the origin mentioned above becomes shorter. The increasing or decreasing amount designation 22 designates, between the attention information mentioned above which is set by the attention information setting 21, increasing or decreasing of a border value of a numerical value of the relationship strength which becomes a target for display in the display window mentioned, above. The identification mark assignment 23 extracts, from no-attention information as remaining information which is among a plurality of the information set in advance and mentioned above except the attention information mentioned above, all the information which has the relationship more than the relationship strength designated by this increasing or decreasing designation 22. And determines a coordinate position of each of the no-attention information mentioned above so that the weaker the relationship strength with the attention information mentioned above is, the farther position from the origin of the display window mentioned above the no-attention information is arranged at, and assigns an identification mark to the no-attention information respectively for display. The display control 24 erases, among the identification marks of the no-attention information assigned by the identification mark assignment 23, display of those arranged at a coordinate position closer to the origin than the specific coordinate position in the display window mentioned above. Also, for the no-attention information with the coordinate position other than that, displays the identification mark at each position.

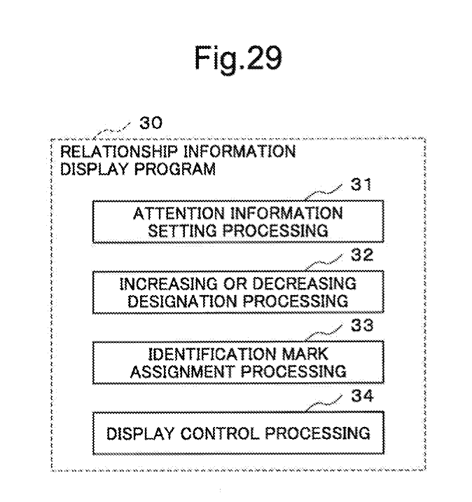

FIG. 29 shows a block diagram of a relationship information display program of other example of the present invention. A relationship information display program 30 of the present invention is made to execute attention information setting processing 31, increasing or decreasing amount designation processing 32, identification mark assignment processing 33 and display control processing 34. Here, the attention information setting processing 31 sets, for a display window, one of information as attention information from a plurality of information which becomes a target to display strength of mutual relationship as relationship strength and set in advance. Here, in the display window, at a fixed single point in an area set in advance, an origin representing the attention information as one of information which should be paid attention is arranged. And, based on a characteristic curve between distance and a display scaling factor set in advance, display is performed such that the display scaling factor approaches zero acceleratingly as the distance with the origin mentioned above becomes shorter. The increasing or decreasing amount designation processing 32 designates, between the attention information mentioned above which is set by the attention information setting processing 31, increasing or decreasing of a border value of a numerical value of the relationship strength which becomes a target for display in the display window mentioned above. The identification mark assignment processing 33 extracts, from no-attention information as remaining information which is among a plurality of the information set in advance and mentioned above except the attention information mentioned above, all the information which has the relationship more than the relationship strength designated by this increasing or decreasing designation processing 32. And determines a coordinate position of each of the no-attention information mentioned above so that the weaker the relationship strength with the attention information mentioned above is, the farther position from the origin of the display window mentioned above the no-attention information is arranged at. After this, assigns an identification mark to the no-attention information respectively for display. The display control processing 34 erases, among the identification marks of the no-attention information assigned by the identification mark assignment processing 33, display of those arranged at a coordinate position closer to the origin than the specific coordinate position in the display window mentioned above. Also, for the no-attention information with the coordinate position other than that, displays the identification mark at each position.

Although a part or the entire exemplary embodiment mentioned above can also be described as following notes, it is not limited to the following.

Note 1) A relationship information display device characterized by including:

a display window setting means which arranges at a fixed point in an area an origin representing attention information as one of information which should be paid attention, and as distance with the origin becomes shorter, based on a characteristic curve between distance and a display scaling factor set in advance, sets a display window in which the display scaling factor approaches zero acceleratingly; an extracted information displaying means which when, from relationship strength information which represents strength of relationship among a plurality of information set in advance, one of the information is made the attention information and the remaining information is made no-attention information, extracts all the no-attention information having the relationship beyond the strength which is designated to the attention information, inputs it into the display window set by the display window setting means so that the designated strength will be arranged at a farthest position from the origin of the display window, and displays by attaching an identification mark representing their information at each of coordinate positions of the inputted no-attention information; a designated value increasing or decreasing means which increases or decreases a designated value of distance relationship; and a display erasing means which erases display of the identification mark of the no-attention information which is positioned at a coordinate position closer to the origin than a specific coordinate position in the display window.

(Note 2) The relationship information display device according to claim 1, wherein characterized by the display window being a circle and the origin being arranged at a center of the circle.

(Note 3) The relationship information display device according to claim 2, wherein characterized by the coordinate position being a position based on a polar coordinate.

(Note 4) The relationship information display device according to claim 2 or claim 3, wherein characterized by, for an arrangement position of the identification mark between the attention information and each of the no-attention information, relative intensity of the relationship being set by width or narrowness of a central angle with the origin as the center and within a predetermined angular range within 180 degrees in the direction of circumference.

(Note 5) The relationship information display device according to claim I characterized by further including: a mark reduced display means which reduces and displays the identification mark such that, the closer to the origin, the further reduced.

(Note 6) The relationship information display device according to claim I characterized by further including: a brightness changing means which changes the brightness as the identification mark is closer to the origin and displays.

(Note 7) The relationship information display device according to claim 1 characterized by further including: a color changing means which displays the identification mark variably with color of visible wavelength area according to the distance from the origin.

(Note 8) The relationship information display device according to claim 5, wherein characterized by the identification mark being a quadrilateral, and further including a distance dependent modification means where length of each side depends on the distance from the origin,

(Note 9) The relationship information display device according to claim 1, wherein characterized by the display window being an elongated rectangle, and the origin being arranged at one end of a long side of the rectangle.

(Note 10)

The relationship information display device according to claim 1 or claim 4, wherein characterized by the display window being a sector and the origin being arranged at a position of a pivot of the sector.

(Note 11) A relationship information display method characterized by including: an attention information setting step which arranges at a fixed single point in an area set in advance an origin representing attention information as one of information which should be paid attention, and based on a characteristic curve between distance and a display scaling factor set in advance, for a display window in which the display scaling factor approaches zero acceleratingly as the distance with the origin becomes shorter, sets one information as the attention information from a plurality of information set in advance which becomes a target to display strength of mutual relationship; an increasing or decreasing step which, between the attention information which is set by the attention information setting step, designates increase or decrease of a boundary value of a numerical value of the relationship strength which becomes a target for display in the display window; an identification mark assigning step which, from no-attention information as remaining information which is among a plurality of the information set in advance except the attention information, extracts all the information which has the relationship more than the relationship strength designated by the increasing or decreasing step, determines a coordinate position of each of the no-attention information so that the weaker the relationship strength with the attention information is, the farther position from the origin of the display window the no-attention information is arranged at, and assigns an identification mark to the no-attention information respectively for display; and a display control step which, among the identification marks of the no-attention information which are assigned by the identification mark assigning step, erases display of those arranged at a coordinate position closer to the origin than the specific coordinate position in the display window, and in addition, for the no-attention information with the coordinate position other than that, displays the identification mark at each position.

(Note 12) A relationship information display program which is characterized by making a computer execute: attention information setting processing which arranges at a fixed single point in an area set in advance an origin representing attention information as one of information which should be paid attention, and based on a characteristic curve between distance and a display scaling factor set in advance, for a display window in which the display scaling factor approaches zero acceleratingly as the distance with the origin becomes shorter, sets one information as the attention information from a plurality of information set in advance which becomes a target to display strength of mutual relationship; increasing or decreasing processing which, between the attention information which is set by the attention information setting step, designates increase or decrease of a boundary value of a numerical value of the relationship strength which becomes a target for display in the display window; identification mark assigning processing which, from no-attention information as remaining information which is among a plurality of the information set in advance except the attention information, extracts all the information which has the relationship more than the relationship strength designated by the increasing or decreasing step, determines a coordinate position of each of the no-attention information so that the weaker the relationship strength with the attention information is, the farther position from the origin of the display window the no-attention information is arranged at, and assigns an identification mark to the no-attention information respectively for display; and display control processing which, among the identification marks of the no-attention information which are assigned by the identification mark assigning step, erases display of those arranged at a coordinate position closer to the origin than the specific coordinate position in the display window, and in addition, for the no-attention information with the coordinate position other than that, displays the identification mark at each position.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application claims priority based on Japanese Patent Application No. 2009-099673 filed on Apr. 16, 2009 and the disclosure thereof is incorporated herein in its entirely.

### INDUSTRIAL AVAILABILITY

The present invention described above can be applied to all uses which display the relationship among a plurality of information. Also, the present invention can be applied to not only an information processing device having up and down keys but also to devices having left and right keys, a cross key or a cursor key similarly. Also, even in a numeric keypad arbitrary two keys can be used. For this reason, as an information processing device to which the present invention is applied, all the devices such as a television including a remote controller or such as a computer including an operation unit can be a target.

Also, a display may not only be the one which can display a circle on a rectangular display screen but also the one which can display a circle on a circular display unit.

1. A relationship information display device characterized by comprising: a relationship information generating unit which, from relationship strength which is set in advance between one attention information selected in advance from a plurality of information which becomes a target to display relationship strength representing a degree of strength of mutual relationship, and one or more no-attention information which are information other than said attention information among said plurality of information, calculates distance between said one or more no-attention information and said attention information by a predetermined method, and generates relationship strength information of said plurality of information including said distance calculated;
a display area moving unit which, in case said distance between said no-attention information and said attention information is included inside, based on directions via an input device and by increasing or decreasing simultaneously a maximum value and a minimum value of a display range which becomes a target which displays a degree of relationship strength of the no-attention information with the attention information, moves said display range;
a. display information generating unit which, based on said distance between said one or more no-attention information and said attention information, calculates display distance which is distance from an origin to a position which displays said no-attention information in a display area for displaying relationship information so that magnitude relationship of said distance does not change in said display distance either and so that a numerical value of said display distance is included in a predetermined fixed range irrespective of where said display range is; and
a display control unit which, in case said distance between said no-attention information and said attention information is included in said display range, controls so that a location on said display screen whose distance from the origin which is positioned at a fixed single point in said display area and represents a position of the attention information equals to said display distance which said display information generating unit calculated is assigned to said no-attention information, displays an identification mark specifying the no-attention information on an output device by superposing it on a figure representing an index of the distance from the origin, and controls to output said display area to said output device.

2. The relationship information display device according to claim 1, wherein characterized by said display control unit reducing said identification mark according to the distance of a display position of the identification mark from the origin and display controlling.

3. The relationship information display device according to claim 2, wherein characterized by said display control unit,
based on a characteristic curve representing relationship between display distance and a display scaling factor set in advance where a numerical value is 1 at the display distance corresponding to a maximum value in said display range and the numerical value approaches zero as the display distance approaches zero and represented by a broken line or a curve which is convex, obtaining the display scaling factor from the display distance which said display information generating unit calculated, and determining size of said identification mark displayed by the display scaling factor.

4. The relationship information display device according to claim 1, wherein characterized by deciding both or one of brightness and color in said display area according to the distance from the origin.

5. The relationship information display device according to claim 1, wherein characterized by a figure representing an index of said distance is one or more circles with said origin as a center.

6. The relationship information display device according to claim 5, wherein characterized by a position of said no-attention information being the position based on a polar coordinate.

7. The relationship information display device according to claim 5, wherein characterized by, based on the relationship strength between each of the no-attention information and by a predetermined method, setting a central angle which the display direction of two of the no-attention information centering the origin forms within a range of 180 degrees, and by the display direction of said each of the no-attention information arranged based on width and narrowness of said central angle being set and said distance between the origin and the position of said each of the no-attention information, determining the display position of said identification mark corresponding to said each of the no-attention information.

8. The relationship information display device according to claim 1, wherein characterized by changing brightness of said identification mark according to the distance of the display position of the identification mark from the origin, and displaying the identification mark.

9. The relationship information display device according to claim 1, wherein characterized by changing color of the identification mark according to the distance of the display position of the identification mark from the origin, and displaying the identification mark.

10. The relationship information display device according to claim 1, wherein characterized by shape of the identification mark being a quadrilateral, and length of each side of the quadrilateral being the length according to the distance between the side and the origin.

11. The relationship information display device according to claim 1, wherein characterized by a figure representing an index of said distance being an elongated rectangle, and said origin being arranged at one end of a long side of the rectangle.

12. The relationship information display device according to claim 1, wherein characterized by a figure representing an index of said distance being a sector, and said origin being arranged at a position of a pivot of the sector.

13. A relationship information display method comprising: from relationship strength which is set in advance between one attention information selected in advance from a plurality of information which becomes a target to display relationship strength representing a degree of strength of mutual relationship, and one or more no-attention information which are information other than said attention information among said plurality of information, calculating distance between said one or more of the no-attention information and said attention information by a predetermined method; generating relationship strength information of said plurality of information including said distance calculated;
in case said distance between said no-attention information and said attention information is included inside, based on directions via an input device and by increasing or decreasing simultaneously a maximum value and a minimum value of a display range which becomes a target which displays a degree of relationship strength of the no-attention information with the attention information, moving said display range;
based on said distance between said one or more of the no-attention information and said attention information, calculating display distance which is distance from an origin to a position which displays said no-attention information in a display area for displaying relationship information so that magnitude relationship of said distance does not change in said display distance either and so that a numerical value of said display distance is included in a predetermined fixed range irrespective of where said display range is;
in case said distance between said no-attention information and said attention information is included in said display range, controlling so that a location on said display screen whose distance from the origin which is positioned at a fixed single point in said display area and represents a position of the attention information equals to said display distance is assigned to said no-attention information; displaying an identification mark specifying the no-attention information on an output device by superposing it on a figure representing an index of the distance from the origin; and controlling to output said display area to said output device.

14. A non-transitory computer readable medium embodying a relationship information display program making a computer execute: relationship information generating processing which, from relationship strength which is set in advance between one attention information selected in advance from a plurality of information which becomes a target to display relationship strength representing a degree of strength of mutual relationship, and one or more no-attention information which are information other than said attention information among said plurality of information, calculates distance between said one or more of the no-attention information and said attention information by a predetermined method, and generates relationship strength information of said plurality of information including said distance calculated;
display area moving processing which, in case said distance between said no-attention information and said attention information is included inside, based on directions via an input device and by increasing or decreasing simultaneously a maximum value and a minimum value of a display range which becomes a target which displays a degree of relationship strength of the no-attention information with the attention information, moves said display range;
display information generating processing which, based on said distance between said one or more of the no-attention information and said attention information, calculates display distance which is distance from an origin to a position which displays said no-attention information in a display area for displaying relationship information so that magnitude relationship of said distance does not change in said display distance either and so that a numerical value of said display distance is included in a predetermined fixed range irrespective of where said display range is; and
display control processing which, in case said distance between said no-attention information and said attention information is included in said display range, controls so that a location on said display screen whose distance from the origin which is positioned at a fixed single point IS in said display area and represents a position of the attention information equals to said display distance which said display information generating processing calculated is assigned to said no-attention information, displays an identification mark specifying the no-attention information on an output device by superposing it on a figure representing an index of the distance from the origin, and controls to output said display area to said output device.

15. A relationship information display device characterized by comprising: a relationship information generating means which, from relationship strength which is set in advance between one attention information selected in advance from a plurality of information which becomes a target to display relationship strength representing a degree of strength of mutual relationship, and one or more no-attention information which are information other than said attention information among said plurality of information, calculates distance between said one or more no-attention information and said attention information by a predetermined method, and generates relationship strength information of said plurality of information including said distance calculated;
a display area moving means which, in case said distance between said no-attention information and said attention information is included inside, based on directions via an input device and by increasing or decreasing simultaneously a maximum value and a minimum value of a display range which becomes a target which displays a degree of relationship strength of the no-attention information with the attention information, moves said display range;
a display information generating means which, based on said distance between said one or more no-attention information and said attention information, calculates display distance which is distance from an origin to a position which displays said no-attention information in a display area for displaying relationship information so that magnitude relationship of said distance does not change in said display distance either and so that a numerical value of said display distance is included in a predetermined fixed range irrespective of where said display range is; and
a display control means which, in case said distance between said no-attention information and said attention information is included in said display range, controls so that a location on said display screen whose distance from the origin which is positioned at a fixed single point in said display area and represents a position of the attention information equals to said display distance which said display information generating means calculated is assigned to said no-attention information, displays an identification mark specifying the no-attention information on an output device by superposing it on a figure representing an index of the distance from the origin, and controls to output said display area to said output device.
